(19) United States
(12) Patent Application Publication
(10) Pub. No.: US 2026/0230988 A1
(43) Pub. Date: Aug. 6, 2026

(54) Enabling continuous conditional cell changes

(71) Applicant: GOOGLE LLC, Mountain View, CA (US)

(72) Inventors: Chih-Hsiang Wu, Taoyuan City (TW); Ching-Jung Hsieh, Taoyuan City (TW)

(21) Appl. No.: 19/149,512

(22) PCT Filed: Jan. 20, 2024
(86) PCT No.: PCT/US2024/012297

§ 371 Date: Jul. 18, 2025

Related U.S. Application Data
(60) Provisional application No. 63/480,955, filed on Jan. 20, 2023.

(51) Int. Cl. H04W 36/36; H04W 36/00

(52) U.S. Cl. CPC H04W 36/362; H04W 36/0061

(57) ABSTRACT

A first node (MN 104A) of a radio access network (RAN) transmits (340), to a second node (S-SN 106B) of the RAN, a request for a reference conditional secondary node (C-SN) configuration related to a continuous primary secondary cell (PSCell) addition or change (CPAC) procedure; receives (342), from the second node and in response to the request, the reference C-SN configuration; and transmits (308), to the UE, a C-SN configuration based on the reference C-SN configuration, for performing a plurality of conditional candidate cell changes based on the C-SN configuration.

### CROSS-REFERENCE TO RELATED APPLICATION

This application claims priority to and the benefit of the filing date of provisional U.S. Patent Application No. 63/480,955, titled “Enabling Continuous Conditional Cell Changes,” filed on Jan. 20, 2023. The entire contents of the provisional application are hereby expressly incorporated herein by reference.

### FIELD OF THE DISCLOSURE

This disclosure relates generally to wireless communications and, more particularly, to managing conditional configurations to enable continuous conditional cell changes.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, a user equipment (UE) sometimes can concurrently utilize resources of multiple radio access network (RAN) nodes, such as base stations or components of a distributed base station, interconnected by a backhaul. When these network nodes support different radio access technologies (RATs), this type of connectivity is referred to as Multi-Radio Dual Connectivity (MR-DC). When a UE operates in MR-DC, one base station operates as a master node (MN) that covers a primary cell (PCell), and the other base station operates as a secondary node (SN) that covers a primary secondary cell (PSCell). The UE communicates with the MN (via the PCell) and the SN (via the PSCell). In other scenarios, the UE transfers a wireless connection from one base station to another base station. For example, a serving base station can determine to hand the UE over to a target base station and initiate a handover procedure.

3GPP specification TS 37.340 v 16.6.0 describes procedures for a UE to add or change an SN in DC scenarios. These procedures involve messaging (e.g., RRC signaling and preparation) between radio access network (RAN) nodes. This messaging generally causes latency, which in turn increases the probability that the SN addition or SN change procedure will fail. These legacy procedures, which do not involve conditions that are checked at the UE, can be referred to as “immediate” SN addition and SN change procedures.

More recently, for both SN or PSCell addition/change, “conditional” procedures have been considered (i.e., conditional SN or PSCell addition/change). Unlike the “immediate” procedures discussed above, these procedures do not add or change the SN or PSCell, or perform the handover, until the UE determines that a condition is satisfied. As used herein, the term “condition” may refer to a single, detectable state or event (e.g., a particular signal quality metric exceeding a threshold), or to a logical combination of such states or events (e.g., “Condition A and Condition B,” or “(Condition A or Condition B) and Condition C”, etc.).

To configure a conditional procedure, the RAN provides the condition to the UE, along with a configuration (e.g., one or more random-access preambles, etc.) that will enable the UE to communicate with the appropriate base station, or via the appropriate cell, when the condition is satisfied. For a conditional addition of a base station as an SN or a candidate cell as a PSCell, for example, the RAN provides the UE with a condition to be satisfied before the UE can add that base station as the SN or that candidate cell as the PSCell, and a configuration that enables the UE to communicate with that base station or PSCell after the condition has been satisfied.

In the immediate PSCell addition or change procedure, the RAN (i.e., MN or SN) transmits an RRC reconfiguration message including multiple configuration parameters to the UE and the UE attempts to connect to a (target) PSCell configured by the RRC reconfiguration message. After the UE successfully connects to the SN via the PSCell, the UE communicates with the SN on the PSCell by using the multiple configuration parameters and security key(s) associated to the PSCell and derived from one or more security configuration parameters in the RRC reconfiguration message. The SN also derives security key(s) that match the security key(s) derived from the UE. After the UE successfully connects to the PSCell, the RAN (e.g., the SN) communicates data with the UE by using the matching security key(s) and the multiple configuration parameters.

In some cases, a candidate SN (C-SN) (or target SN (T-SN), which can be inter-changed with each other throughout this document) provides multiple candidate configurations when, for example, multiple candidate PSCells are available. When the MN completes the preparation for a conditional SN procedure (e.g., conditional SN addition or conditional SN cell change), the MN at this time cannot determine which candidate secondary cell the UE will connect to in the future. Moreover, because the UE connects to the secondary cell only subject to the fulfillment of one or more conditions, the MN cannot determine whether the UE will even connect to any of the candidate cells in the future.

According to the 3GPP Release 17 Conditional PSCell change (CPC)/Conditional PSCell addition or change (CPAC) group of procedures, the RAN (e.g., the MN or SN) can transmit multiple candidate configurations to the UE. However, when the UE determines that a triggering condition is satisfied for a specific one of the candidate configurations, the UE executes the specific candidate configuration and performs random access towards a candidate PSCell configured in the specific candidate configuration. The UE releases the configurations after completing random access towards the candidate PSCell. Because the UE releases all of the candidate configurations, the UE does not have a chance to perform subsequent CPAC without receiving new candidate configuration(s) from the network.

Recently, 3GPP proposed to develop continuous CPAC (i.e., subsequent CPAC after a CPAC) without new CPAC preparation from the network. “Continuous CPAC” is also referred to as an MR-DC with selective activation of cell groups, aiming at reducing the signaling overhead between an MN and C-SNs and between the MN and a UE, well as reducing the interruption time for SCG change. However, it is not clear how the MN can ensure that the RAN and the UE use the same candidate configuration to communicate with each other when the triggering condition is satisfied during the continuous CPAC operations, nor is it clear how the MN should prepare conditional configurations for continuous CPAC, especially for multiple candidate SNs. Moreover, it is not clear how an MN can generate a conditional configuration for continuous CPAC configuration efficiently.

### SUMMARY

An example embodiment of these techniques is a method implemented in a first node of a radio access network (RAN). The method comprises transmitting, to a second node of the RAN, a request for a reference conditional secondary node (C-SN) configuration related to a continuous primary secondary cell (PSCell) addition or change (CPAC) procedure; receiving, from the second node and in response to the request, the reference C-SN configuration; and transmitting, to the UE, a C-SN configuration based on the reference C-SN configuration, for performing a plurality of conditional cell changes based on the C-SN configuration.

Another example embodiment of these techniques is a method implemented in a second node of a RAN. The method comprises receiving, from a first node of the RAN, a request for a reference conditional secondary node (C-SN) configuration related to a continuous primary secondary cell (PSCell) addition or change (CPAC) procedure; and transmitting, to the first node and in response to the request, the reference C-SN configuration.

Another example embodiment of these techniques is a node in a radio access network (RAN) comprising a transceiver and processing hardware, the node configured to implement one of the methods above.

### BRIEF DESCRIPTION OF THE DRAWINGS

FIG. 1A is a block diagram of an example system in which a base station and/or a user equipment (UE) can implement the techniques of this disclosure for managing conditional procedures related to a master node (MN) or a secondary node (SN);

FIG. 1B is another block diagram of an example system in which a radio access network (RAN) and a user device can implement the techniques of this disclosure for managing conditional procedures related to an MN or an SN;

FIG. 1C is a block diagram of an example base station including a central unit (CU) and a distributed unit (DU) that can operate in the system of FIG. 1A or FIG. 1B;

FIG. 2 is a block diagram of an example protocol stack according to which the UE of FIGS. 1A-1B can communicate with base stations;

FIG. 3A is a messaging diagram of an example scenario where an MN receives and processes one or more SN configurations from a C-SN during a Conditional SN Addition procedure for continuous CPAC;

FIG. 3B is a messaging diagram of an example scenario where an MN receives and processes one or more SN configurations from a C-SN during an MN-initiated Conditional SN Change procedure for continuous CPAC;

FIG. 3C is a messaging diagram of an example scenario where an MN receives and processes one or more SN configurations from a C-SN during an SN-initiated Conditional SN Change scenario for continuous CPAC;

FIG. 4A is a messaging diagram of an example scenario where the SN initiates an intra-SN continuous CPAC via the MN;

FIG. 4B is a messaging diagram of an example scenario where the SN initiates an intra-SN continuous CPAC without MN involvement;

FIG. 5 is a flow diagram of an example method where an MN initiates continuous CPAC with a C-SN for a UE with an obtained reference C-SN configuration;

FIG. 6 is a flow diagram of an example method where an S-SN initiates a conditional SN Change procedure with an MN toward one or more C-SNs for a UE and provides a reference C-SN configuration;

FIG. 7 is a flow diagram of an example method where an SN performs an SN procedure for a UE with an MN to provide a reference C-SN configuration;

FIGS. 8A-8B is a flow diagram of an example method where an SN performs a SN procedure for a UE with an MN to provide a reference C-SN configuration as a full configuration;

FIG. 9 is a flow diagram of an example method where an MN performs an SN procedure for a UE with an SN to query an SN configuration;

FIG. 10 is a flow diagram of an example method where an MN performs an SN procedure for a UE with an SN and handles a received SN configuration;

FIG. 11 is a flow diagram of an example method where an SN performs an SN procedure for a UE with an MN and provides an SN configuration in accordance to a query;

FIGS. 12A-12B is a flow diagram of an example method where an MN performs an SN procedure for a UE with an C-SN and handles a received C-SN configuration for continuous CPAC;

FIG. 13 is a flow diagram of an example a method where a UE performs continuous CPAC with a RAN using a reference C-SN configuration and a first SN configuration;

FIGS. 14A and 14B are flow diagram of example methods where a UE performs a continuous CPAC with a RAN using a plurality of reference C-SN configurations and a C-SN configuration;

FIGS. 15A and 15B are flow diagrams of example methods where a UE performs a continuous CPAC with a RAN using either a reference C-SN configuration or a first SN configuration and a C-SN configuration;

FIG. 16 is a flow diagram of an example method where a UE performs a continuous CPAC with a RAN using a reference C-SN configuration, a C-SN configuration, and/or a first SN configuration;

FIG. 17 is a flow diagram of an example method where a UE performs a continuous CPAC with a RAN using a reference C-SN configuration, a plurality of C-SN configurations, and/or a first SN configuration;

FIG. 18 is a flow diagram of an example method where a UE performs a continuous CPAC with a RAN using a reference C-SN configuration, a plurality of C-SN configurations, and/or a first SN configuration;

FIG. 19 is a flow diagram of an example method where a UE performs a continuous CPAC procedure with a RAN and handles a reference C-SN configuration depending on whether the UE is able to comply with the reference C-SN configuration; and

FIGS. 20A and 20B are flow diagrams of example methods where a UE performs a continuous CPAC procedure with a RAN using a reference C-SN configurations and handles network failure.

### DETAILED DESCRIPTION OF THE DRAWINGS

As discussed in detail below, a UE and/or one or more base stations manage conditional procedures, such as conditional PSCell addition or change (CPAC). This disclosure may also refer to a conditional PSCell addition procedure and a conditional PSCell change procedure separately using the acronyms CPA and CPC, respectively.

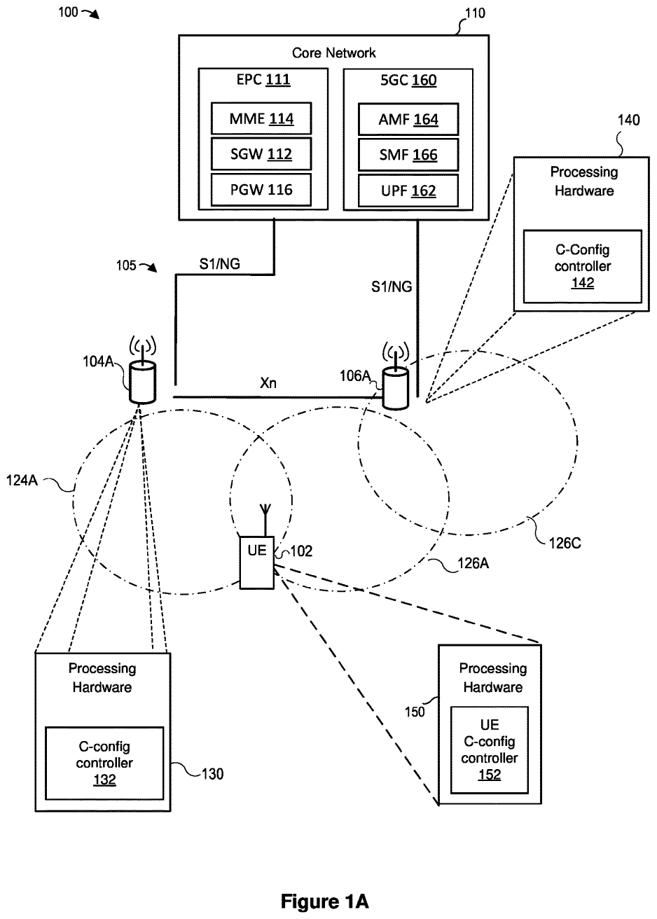

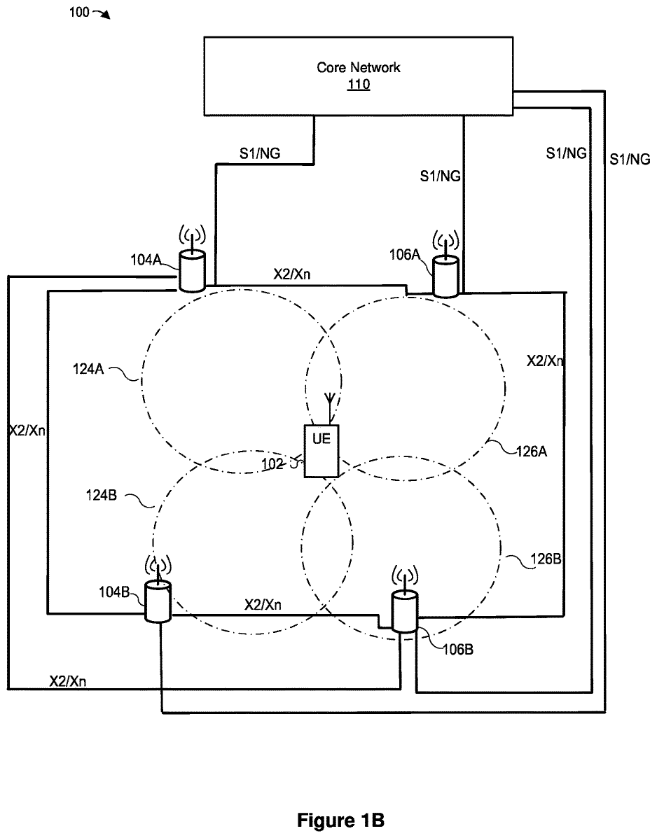

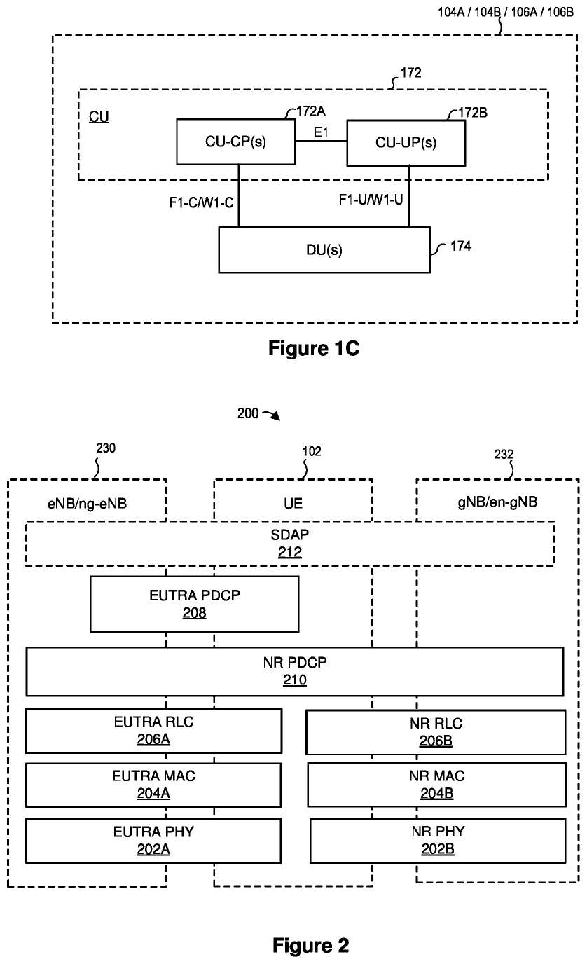

Referring first to FIG. 1A, an example wireless communication system 100 includes a UE 102, a base station (BS) 104A, a base station 106A, and a core network (CN) 110. The base stations 104A and 106A can operate in a RAN 105 connected to the same core network (CN) 110. The CN 110 can be implemented as an evolved packet core (EPC) 111 or a fifth generation (5G) core (5GC) 160, for example.

Among other components, the EPC 111 can include a Serving Gateway (SGW) 112, a Mobility Management Entity (MME) 114, and a Packet Data Network Gateway (PGW) 116.

The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc.; the AMF 164 is configured to manage authentication, registration, paging, and other related functions; and the SMF 166 is configured to manage PDU sessions.

As illustrated in FIG. 1A, the base station 104A supports a cell 124A, and the base station 106A supports a cell 126A. Further, each of the base stations 104A, 106A may support more than one cell. The base station 106A, for example, may also support a cell 126C. The cells 124A and 126A can partially overlap, so that the UE 102 can communicate in DC with the base station 104A and the base station 106A operating as a master node (MN) and a secondary node (SN), respectively. To directly exchange messages during DC scenarios and other scenarios discussed below, the MN 104A and the SN 106A can support an X2 or Xn interface. In general, the CN 110 can connect to any suitable number of base stations supporting NR cells and/or EUTRA cells. An example configuration in which the EPC 110 is connected to additional base stations is discussed below with reference to FIG. 1B.

The base station 104A is equipped with processing hardware 130 that can include one or more general-purpose processors such as CPUs and non-transitory computer-readable memory storing machine-readable instructions executable on the one or more general-purpose processors, and/or special-purpose processing units. The processing hardware 130 in an example implementation includes a conditional configuration controller 132 configured to manage conditional configuration for one or more conditional procedures such as Conditional Handover (CHO), Conditional PSCell Addition or Change (CPAC), or Conditional SN Additional or Change (CSAC), when the base station 104A operates as an MN.

The base station 106A is equipped with processing hardware 140 that can also include one or more general-purpose processors such as CPUs and non-transitory computer-readable memory storing machine-readable instructions executable on the one or more general-purpose processors, and/or special-purpose processing units. The processing hardware 140 in an example implementation includes a conditional configuration controller 142 configured to manage conditional configurations for one or more conditional procedures such as CHO, CPAC, or CSAC, when the base station 106A operates as an SN.

Still referring to FIG. 1A, the UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a UE conditional configuration controller 152 configured to manage conditional configuration for one or conditional procedures.

More particularly, the conditional configuration controllers 132, 142, and 152 can implement at least some of the techniques discussed with reference to the messaging and flow diagrams below. Although FIG. 1A illustrates the conditional configuration controllers 132 and 142 as separate components, in at least some of the scenarios the base stations 104A and 106A can have similar implementations and in different scenarios operate as MN or SN nodes. In these implementations, each of the base stations 104A and 106A can implement both the conditional configuration controller 132 and the conditional configuration controller 142 to support MN and SN functionality, respectively.

In operation, the UE 102 can use a radio bearer (e.g., a DRB or an SRB) that at different times terminates at the MN 104A or the SN 106A. The UE 102 can apply one or more security keys when communicating on the radio bearer, in the uplink (from the UE 102 to a BS) and/or downlink (from a base station to the UE 102) direction. The UE in some cases can use different RATs to communicate with the base stations 104A and 106A. Although the examples below may refer specifically to specific RAT types, 5G NR or EUTRA, in general the techniques of this disclosure also can apply to other suitable radio access and/or core network technologies.

FIG. 1B depicts additional base stations 104B and 106B, which may be included in the wireless communication system 100. The UE 102 initially connects to the base station 104A. The BSs 104B and 106B may have similar processing hardware as the base station 106A. The UE 102 initially connects to the base station 104A.

In some scenarios, the base station 104A can perform immediate SN addition to configure the UE 102 to operate in dual connectivity (DC) with the base station 104A (via a PCell) and the base station 106A (via a PSCell other than cell 126A). The base stations 104A and 106A operate as an MN and an SN for the UE 102, respectively. The UE 102 in some cases can operate using the MR-DC connectivity mode, e.g., communicate with the base station 104A using 5G NR and communicate with the base station 106A using EUTRA, or communicate with the base station 104A using EUTRA and communicate with the base station 106A using 5G NR. Multi-connectivity coordination can help the two base stations coordinate shared UE capabilities including operational frequencies (e.g., band combinations, frequency ranges), UE measurements and reporting (e.g., intra-frequency measurements, inter-frequency measurements, inter-RAT measurements, measurement gaps), reception timing (e.g., DRX configurations, offset timing), and uplink power control (e.g., power headroom, maximum transmit power).

At some point, the MN 104A can perform an immediate SN change to change the SN of the UE 102 from the base station 106A (source SN, or “S-SN”) to the base station 104B (target SN, or “T-SN”) while the UE 102 is communicating in DC with the MN 104A and the S-SN 106A. In another scenario, the SN 106A can perform an immediate PSCell change to change the PSCell of the UE 102 to the cell 126A. In one implementation, the SN 106A can transmit a configuration changing the PSCell to cell 126A to the UE 102 via a signaling radio bearer (SRB) (e.g., SRB3) for the immediate PSCell change. In another implementation, the SN 106A can transmit a configuration changing the PSCell to the cell 126A to the UE 102 via the MN 104A for the immediate PSCell change. The MN 104A may transmit the configuration immediately changing the PSCell to the cell 126A to the UE 102 via SRB1. Extending multi-connectivity coordination can help the newly-added base station coordinate shared UE capabilities.

In other scenarios, the base station 104A can perform a conditional SN Addition procedure to first configure the base station 106B as a C-SN for the UE 102, i.e., conditional SN addition or change (CSAC). At this time, the UE 102 can be in single connectivity (SC) with the base station 104A or in DC with the base station 104A and the base station 106A. If the UE 102 is in DC with the base station 104A and the base station 106A, the MN 104A may determine to perform the conditional SN Addition procedure in response to a request received from the base station 106A or in response to one or more measurement results received from the UE 102 (e.g., extracted from a UE measurement report) or obtained by the MN 104A from measurements on signals (e.g., sounding reference signal (SRS) or uplink demodulation reference signal (DMRS)) received from the UE 102. In contrast to the immediate SN Addition case discussed above, the UE 102 does not immediately attempt to connect to the C-SN 106B. In this scenario, the base station 104A again operates as an MN, but the base station 106B initially operates as a C-SN rather than an SN.

More particularly, when the UE 102 receives a configuration for the C-SN 106B, the UE 102 does not connect to the C-SN 106B until the UE 102 has determined that a certain condition is satisfied (the UE 102 in some cases can consider multiple conditions, but for convenience only the discussion below refers to a single condition). Before the condition is satisfied, multi-connectivity coordination is not necessary; however, it will be helpful as soon as a C-SN becomes connected. When the UE 102 determines that the condition has been satisfied, the UE 102 connects to the C-SN 106B, so that the C-SN 106B begins to operate as the SN 106B for the UE 102. Thus, while the base station 106B operates as a C-SN rather than an SN, the base station 106B is not yet connected to the UE 102, and accordingly is not yet servicing the UE 102. In some implementations, the UE 102 may disconnect from the SN 106A to connect to the C-SN 106B.

In yet other scenarios, the UE 102 is in DC with the MN 104A (via a PCell) and SN 106A (via a PSCell other than cell 126A and not shown in FIG. 1A). The SN 106A can perform conditional PSCell addition or change (CPAC) to configure a candidate PSCell (C-PSCell) 126A for the UE 102. If the UE 102 is configured with a signaling radio bearer (SRB) (e.g., SRB3) to exchange RRC messages with the SN 106A, the SN 106A may transmit a configuration for the C-PSCell 126A to the UE 102 via the SRB, e.g., in response to one or more measurement results, which may be received from the UE 102 via the SRB or via the MN 104A or may be obtained by the SN 106A from measurements on signals received from the UE 102. In case of via the MN 104A, the MN 104A receives the configuration for the C-PSCell 126A. In contrast to the immediate PSCell change case discussed above, the UE 102 does not immediately disconnect from the PSCell and attempt to connect to the C-PSCell 126A.

More particularly, when the UE 102 receives a configuration for the C-PSCell 126A, the UE 102 does not connect to the C-PSCell 126A until the UE 102 has determined that a certain condition is satisfied (the UE 102 in some cases can consider multiple conditions, but for convenience only the discussion below refers to a single condition). When the UE 102 determines that the condition has been satisfied, the UE 102 connects to the C-PSCell 126A, so that the C-PSCell 126A begins to operate as the PSCell 126A for the UE 102. Thus, while the cell 126A operates as a C-PSCell rather than a PSCell, the SN 106A may not yet connect to the UE 102 via the cell 126A. In some implementations, the UE 102 may disconnect from the PSCell to connect to the C-PSCell 126A.

In some scenarios, the condition associated with CSAC or CPAC can be signal strength/quality, which the UE 102 detects on the C-PSCell 126A of the SN 106A or on a C-PSCell 126B of C-SN 106B, exceeding a certain threshold or otherwise corresponding to an acceptable measurement. For example, when the one or more measurement results the UE 102 obtains on the C-PSCell 126A are above a threshold configured by the MN 104A or the SN 106A or above a pre-determined or pre-configured threshold, the UE 102 determines that the condition is satisfied. When the UE 102 determines that the signal strength/quality on the C-PSCell 126A of the SN 106A is sufficiently good (again, measured relative to one or more quantitative thresholds or other quantitative metrics), the UE 102 can perform a random access procedure on the C-PSCell 126A with the SN 106A to connect to the SN 106A. After the UE 102 successfully completes the random access procedure on the C-PSCell 126A, the C-PSCell 126A becomes a PSCell 126A for the UE 102. The SN 106A then can start communicating data (user-plane data or control-plane data) with the UE 102 through the PSCell 126A. In another example, when the one or more measurement results the UE 102 obtains on the C-PSCell 126B are above a threshold configured by the MN 104A or the C-SN 106B or above a pre-determined or pre-configured threshold, the UE 102 determines that the condition is satisfied. When the UE 102 determines that the signal strength/quality on the C-PSCell 126B of the C-SN 106B is sufficiently good (again, measured relative to one or more quantitative thresholds or other quantitative metrics), the UE 102 can perform a random access procedure on the C-PSCell 126B with the C-SN 106B to connect to the C-SN 106B. After the UE 102 successfully completes the random access procedure on the C-PSCell 126B, the C-PSCell 126B becomes a PSCell 126B for the UE 102 and the C-SN 106B becomes an SN 106B. The SN 106B then can start communicating data (user-plane data or control-plane data) with the UE 102 through the PSCell 126B.

In various configurations of the wireless communication system 100, the base station 104A can be implemented as a master eNB (MeNB) or a master gNB (MgNB), and the base station 106A or 106B can be implemented as a secondary gNB (SgNB) or a candidate SgNB (C-SgNB). The UE 102 can communicate with the base station 104A and the base station 106A or 106B (106A/B) via the same RAT such as EUTRA or NR, or different RATs. When the base station 104A is an MeNB and the base station 106A is an SgNB, the UE 102 can be in EUTRA-NR DC (EN-DC) with the MeNB and the SgNB. In this scenario, the MeNB 104A can configure the base station 106B as a C-SgNB to the UE 102. In this scenario, the SgNB 106A may configure cell 126A as a C-PSCell to the UE 102. When the base station 104A is an MeNB and the base station 106A is a C-SgNB for the UE 102, the UE 102 can be in SC with the MeNB. In this scenario, the MeNB 104A can configure the base station 106B as another C-SgNB to the UE 102.

In some cases, an MeNB, an SeNB or a C-SgNB is implemented as an ng-eNB rather than an eNB. When the base station 104A is a Master ng-eNB (Mng-eNB) and the base station 106A is a SgNB, the UE 102 can be in next generation (NG) EUTRA-NR DC (NGEN-DC) with the Mng-eNB and the SgNB. In this scenario, the MeNB 104A can configure the base station 106B as a C-SgNB to the UE 102. In this scenario, the SgNB 106A may configure cell 126A as a C-PSCell to the UE 102. When the base station 104A is an Mng-NB and the base station 106A is a C-SgNB for the UE 102, the UE 102 can be in SC with the Mng-NB. In this scenario, the Mng-eNB 104A can configure the base station 106B as another C-SgNB to the UE 102.

When the base station 104A is an MgNB and the base station 106A/B is an SgNB, the UE 102 may be in NR-NR DC (NR-DC) with the MgNB and the SgNB. In this scenario, the MeNB 104A can configure the base station 106B as a C-SgNB to the UE 102. In this scenario, the SgNB 106A may configure cell 126A as a C-PSCell to the UE 102. When the base station 104A is an MgNB and the base station 106A is a C-SgNB for the UE 102, the UE 102 may be in SC with the MgNB. In this scenario, the MgNB 104A can configure the base station 106B as another C-SgNB to the UE 102.

When the base station 104A is an MgNB and the base station 106A/B is a Secondary ng-eNB (Sng-eNB), the UE 102 may be in NR-EUTRA DC (NE-DC) with the MgNB and the Sng-eNB. In this scenario, the MgNB 104A can configure the base station 106B as a C-Sng-eNB to the UE 102. In this scenario, the Sng-eNB 106A may configure cell 126A as a C-PSCell to the UE 102. When the base station 104A is an MgNB and the base station 106A is a candidate Sng-eNB (C-Sng-eNB) for the UE 102, the UE 102 may be in SC with the MgNB. In this scenario, the MgNB 104A can configure the base station 106B as another C-Sng-eNB to the UE 102.

The base stations 104A, 106A, and 106B can connect to the same core network (CN) 110, which can be an evolved packet core (EPC) 111 or a fifth-generation core (5GC) 160. The base station 104A can be implemented as an eNB supporting an S1 interface for communicating with the EPC 111, an ng-eNB supporting an NG interface for communicating with the 5GC 160, or as a base station that supports the NR radio interface as well as an NG interface for communicating with the 5GC 160. The base station 106A can be implemented as an EN-DC gNB (en-gNB) with an S1 interface to the EPC 111, an en-gNB that does not connect to the EPC 111, a gNB that supports the NR radio interface as well as an NG interface to the 5GC 160, or a ng-eNB that supports an EUTRA radio interface as well as an NG interface to the 5GC 160. To directly exchange messages during the scenarios discussed below, the base stations 104A, 106A, and 106B can support an X2 or Xn interface.

As illustrated in FIG. 1B, the base station 104A supports a cell 124A, the base station 104B supports a cell 124B, the base station 106A supports a cell 126A, and the base station 106B supports a cell 126B. The cells 124A and 126A can partially overlap, as can the cells 124A and 124B, so that the UE 102 can communicate in DC with the base station 104A (operating as an MN) and the base station 106A (operating as an SN) and, upon completing an SN change, with the base station 104A (operating as MN) and the SN 104B. More particularly, when the UE 102 operates in DC with the base station 104A and the base station 106A, the base station 104A operates as an MeNB, an Mng-eNB, or an MgNB, and the base station 106A operates as an SgNB or an Sng-eNB. The cells 124A and 126B can partially overlap. When the UE 102 is in SC with the base station 104A, the base station 104A operates as an MeNB, an Mng-eNB or an MgNB, and the base station 106B operates as a C-SgNB or a C-Sng-eNB. When the UE 102 operates in DC with the base station 104A and the base station 106A, the base station 104A operates as an MeNB, an Mng-eNB or an MgNB, the base station 106A operates as an SgNB or an Sng-eNB, and the base station 106B operates as a C-SgNB or a C-Sng-eNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

FIG. 1C depicts an example distributed implementation of a base station such as the base station 104A, 104B, 106A, or 106B. The base station in this implementation can include a central unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an (C-)SN RRC controller configured to manage or control one or more RRC configurations and/or RRC procedures when the base station 106A operates as an SN or a candidate SN (C-SN). The base station 106B can have hardware same as or similar to the base station 106A. The DU 174 is also equipped with processing hardware that can include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random access procedure) and a radio link control (RLC) controller configured to manage or control one or more RLC operations or procedures when the base station 106A operates as an MN, an SN or a candidate SN (C-SN). The processing hardware may include further a physical layer controller configured to manage or control one or more physical layer operations or procedures.

FIG. 2 illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2). The UE 102, in some implementations, supports both the EUTRA and the NR stack, as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or an RRC sublayer (not shown in FIG. 2) to exchange RRC messages or non-access-stratum (NAS) messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, Internet Protocol (IP) packets, or Ethernet packets.

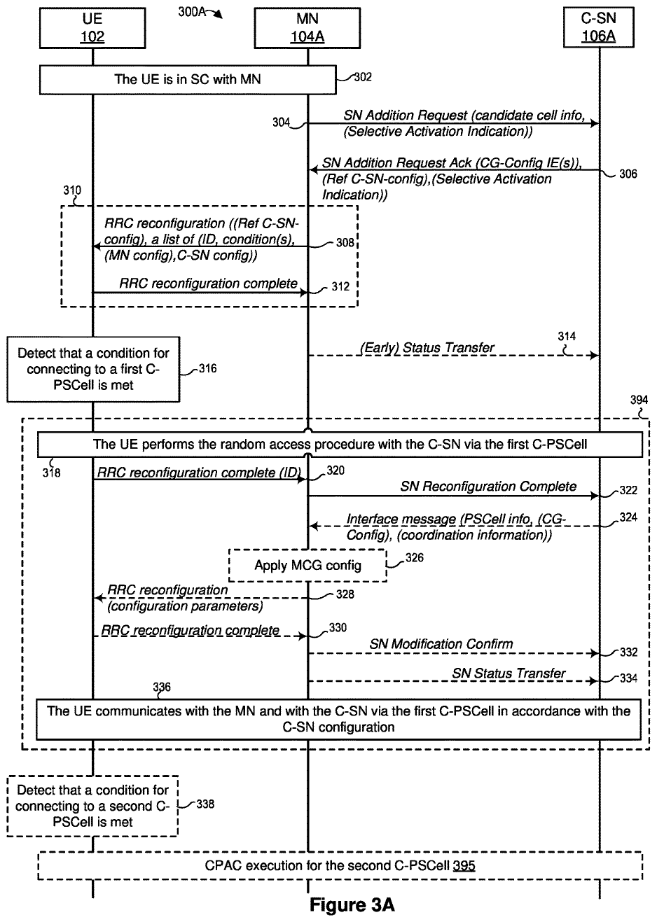

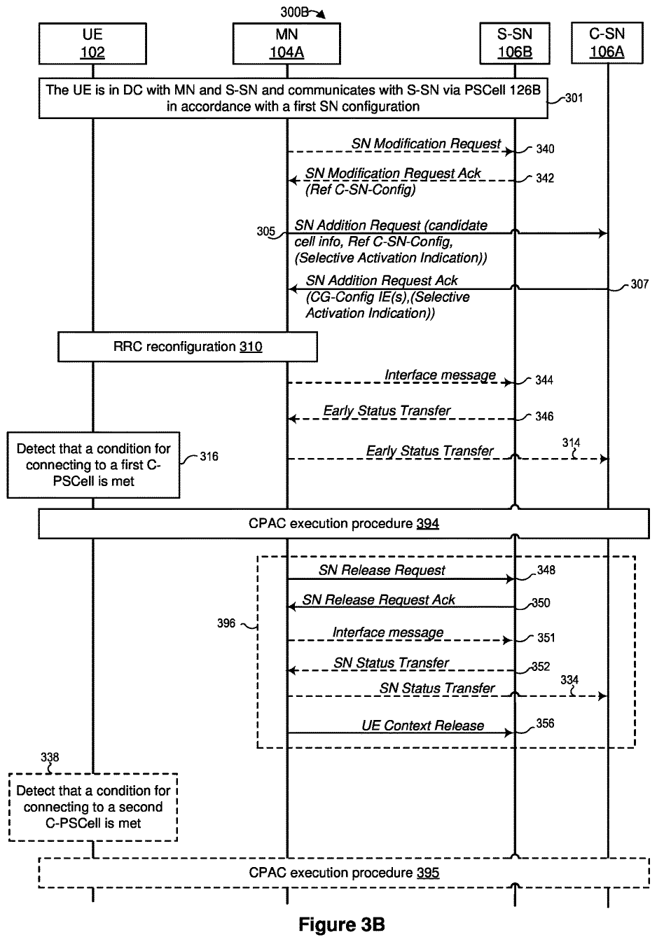

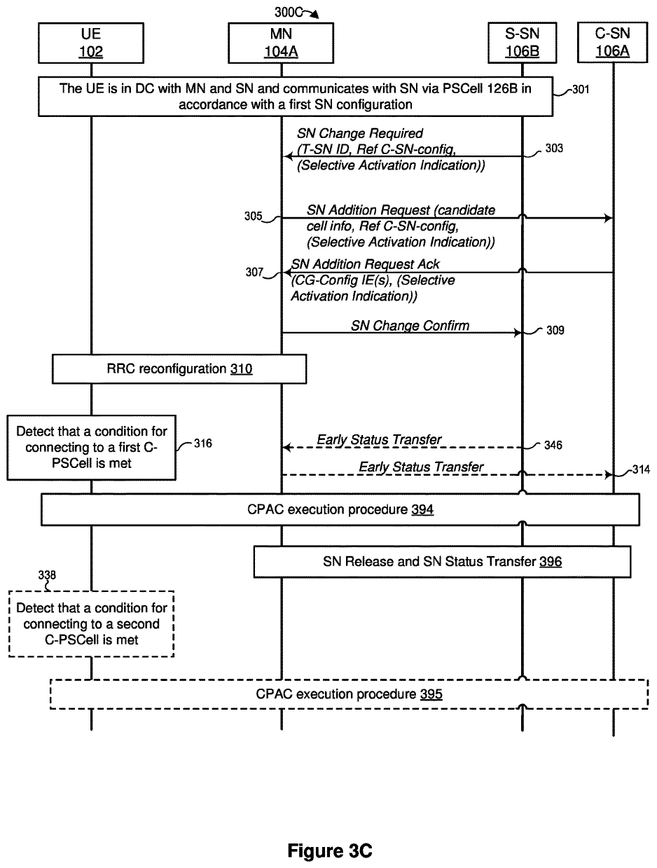

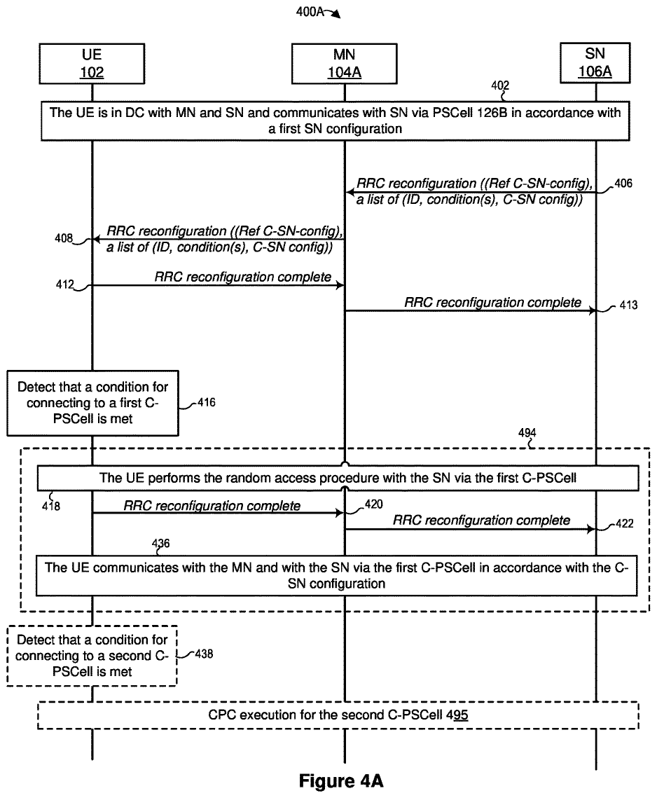

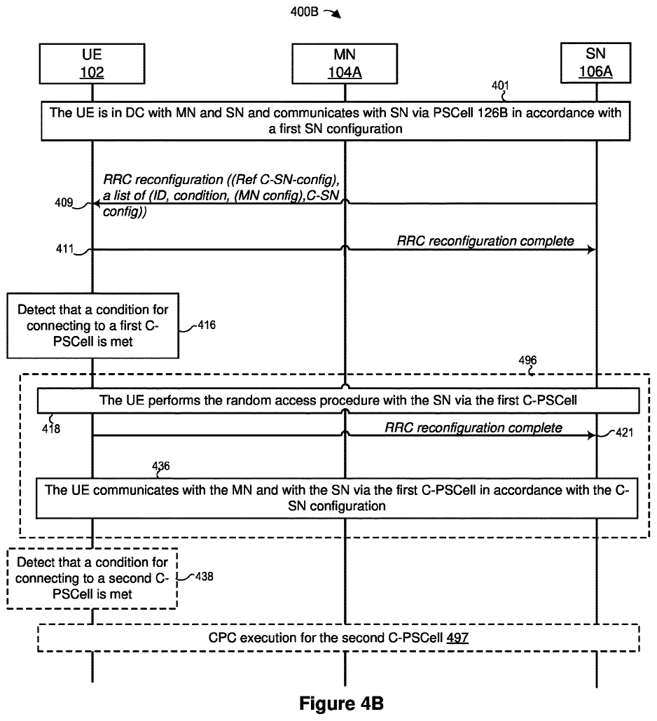

Next, several example scenarios in which a UE and/or a RAN perform the techniques of this disclosure for supporting conditional procedures are discussed with reference to FIGS. 3A-3C and 4A-B. Generally speaking, similar events in FIGS. 3A-3C and 4A-B are labeled with the same reference numbers, with differences discussed below where appropriate.

Referring first to FIG. 3A, in a scenario 300A, an MN receives and processes one or more C-SN configurations from a C-SN during a conditional SN addition procedure. In the scenario 300A, the base station 104A in a scenario 300A operates as an MN, and the base station 106A operates as a C-SN. Initially, the UE 102 operates 302 in single connectivity (SC) with the MN 104A. While in SC, the UE 102 communicates UL PDUs and/or DL PDUs with the MN 104A (e.g., via a PCell 124A) in accordance with an MN configuration.

At a later time, the MN 104A determines to configure the base station 106A as a C-SN for conditional PSCell addition (CPA) for the UE 102. The MN 104A can make this determination based on measurement result(s) from the UE 102, for example. In some implementations, the UE 102 performs measurements and transmits the measurement result(s) in accordance with a measurement configuration configured by the MN 104A. In some implementations, the MN 104A can detect or estimate that the UE 102 is moving toward coverage (i.e., one or more cells) of the base station 106A based on uplink signals received from the UE 102 or positioning measurement result(s) received from the UE 102. In response to the determination, the MN 104A sends 304 a SN Addition Request message including a first indication (e.g., Selective Activation Indication IE) for continuous CPAC to the C-SN 106A. In the description of this invention, “continuous CPAC” is also referred to as a MR-DC with selective activation of cell groups. In some implementations, the MN 104A includes Conditional PSCell Addition (CPA) information (e.g., Conditional PSCell Addition Information Request IE) in the SN Addition Request message. In one implementation, the Conditional PSCell Addition Information Request IE includes a Maximum Number of PSCells To Prepare IE/field. In some implementation, the MN 104A includes the first indication in the Conditional PSCell Addition Information Request IE. In other implementations, the MN 104A includes the first indication and Conditional PSCell Addition Information Request IE as different IEs (e.g., XnAP or X2AP IEs) of the SN Addition Request message.

In some implementations, the MN 104A generates a candidate cell information (e.g., CandidateCellInfoListMN) including the measurement result(s) of the one or more cells and include the candidate cell information in the SN Addition Request message. In some implementations, the MN 104A determines SN restriction information to restrict (values of) configuration parameters that the C-SN 106A can configure for the UE 102, and includes the SN restriction information in the SN Addition Request message. In some implementations, the MN 104A includes the candidate cell information and/or the SN restriction information in an inter-node RRC message (i.e., CG-ConfigInfo IE) and include the inter-node RRC message in the SN Addition Request message. Alternatively, the MN 104A includes the SN restriction information outside of the CG-ConfigInfo in the SN Addition Request message. The MN 104A may determine MN restriction information to restrict (values of) configuration parameters that the MN 104A can configure for the UE 102 when determining the SN restriction information. In some implementations, the MN 104A includes CPA information in the SN Addition Request message. For example, the CPA information (e.g., Conditional PSCell Addition Information Request IE) includes an IE indicating the maximum number of PSCells that the C-SN 106A may prepare.

In some implementations, the MN 104A includes a reference C-SN configuration in the SN Addition Request message for the purpose of continuous CPAC. The MN 104A can obtain the reference C-SN configuration (e.g., C-SN configuration 0) from a C-SN (e.g., C-SN 0). Alternatively, the MN 104A can be pre-configured with the reference C-SN configuration. As yet another alternative, the MN 104A generates the reference C-SN configuration. In other implementations, the MN 104A refrains from including a reference C-SN configuration in the SN Addition Request message, when MN 104A decides to perform CPA to the C-SN 106A and there is no available reference C-SN configuration.

In response to receiving 304 the SN Addition Request message with CPAC indication and/or the first indication and/or the reference C-SN configuration, the C-SN 106A determines M₁ C-PSCell(s) (where M₁ is a positive integer), and generates an inter-node message (e.g., CG-CandidateList) to include C-SN configuration(s) 1, . . . , M₁ for the UE 102, where each C-SN configuration is associated with a particular C-PSCell of the M₁ C-PSCell(s) (i.e., C-PSCell(s) 1, . . . , M₁). For example, the C-PSCell(s) includes the cell 126A and/or the cell 126C. In some implementations, M₁ is not larger than the maximum number of PSCells which can be received in the SN Addition Request message or determined by the C-SN 106A. In some implementations, the C-SN 106A determines the C-PSCell(s) and the C-SN configuration(s) 1, . . . , M₁ taking into account the candidate cell information and the SN restriction information. The inter-node message includes an addition list (e.g., cg-CandidateToAddModList) of CG-CandidateInfo IE(s), where each corresponds to a C-PSCell. Each CG-CandidateInfo IE in the addition list includes a CG-CandidateInfo ID (e.g., cg-CandidateInfoId or CG-CandidateInfoId that includes C-PSCell information for a C-PSCell (e.g., SSB frequency information (e.g., ARFCN-ValueNR)) and the physical Cell ID (PCI)) and a CG-Config IE. Each CG-Config IE includes a C-SN configuration for a corresponding C-PSCell and optionally parameters for the MN 104A to prepare a corresponding MN configuration to coordinate with the C-SN configuration, if necessary. The CG-CandidateInfo ID(s) can be used by the C-SN 106A and the MN 104A for management of CG-CandidateInfo IE(s) in the addition list. In some implementations, the MN 104A uses the first indication to indicate to the C-SN 106A that, different from conventional or 3GPP Release 17 CPAC procedure, the prepared C-SN configuration(s) will not be released by the UE 102 when UE 102 accesses one of the C-SN configuration(s) from the C-SN 106A or other C-SN(s).

The C-SN 106A transmits 306 an SN Addition Request Acknowledge message including the CG-CandidateList and/or a Conditional PSCell Addition Information Acknowledge IE including the list of accepted candidate cell (CGI) to the MN 104A in response to the SN Addition Request message. The C-SN 106A includes the M₁ C-SN configuration(s) in the CG-CandidateList. In some implementations, the C-SN 106A includes a reference C-SN configuration (e.g., Ref C-SN-config) in the SN Addition Request Acknowledge message for the MN 104A to prepare CPAC with other C-SN(s) for the UE 102 as described below. In some implementations, the C-SN 106A includes the reference C-SN configuration and the CG-CandidateList in separate IEs (e.g., XnAP or X2AP IEs) of the SN Addition Request Acknowledge message. In other implementations, the C-SN 106A includes the reference C-SN configuration in the CG-CandidateList IE. In some implementations, the MN 104A includes an indication to request a reference C-SN configuration. The C-SN 106A includes the reference C-SN configuration in the SN Addition Request Acknowledge message in response to the indication. The indication can be an IE such as query IE (e.g., Reference C-SN Configuration Query), a reference configuration request IE or reference configuration indication IE. In some implementations, each of the M₁ C-SN configuration(s) is a delta configuration augmenting the reference C-SN configuration. In other words, the MIC-SN configuration(s) is associated with the reference C-SN configuration. In other implementations, the C-SN 106A refrains from including a reference C-SN configuration in the SN Addition Request Acknowledge message.

After receiving 306 the SN Addition Request Acknowledge message including the CG-CandidateList, the MN 104A can assign a particular configuration ID (e.g., condReconfigId or CondReconfigurationId) to each of the C-SN configuration(s) in the CG-Config IE(s). For example, in cases where the CG-Config IE(s) 1, . . . , M₁ include the C-SN configuration(s) 1, . . . , M₁, the MN 104A can assign configuration ID(s) 1, . . . , M₁ for the C-SN configuration(s) 1, . . . , M₁, respectively. The MN 104A can generate the triggering condition configuration(s) (e.g., condExecutionCond field(s)/IE(s) for the C-SN configuration(s) 1, . . . , M₁, respectively. Each of the triggering condition configuration(s) can configure one or more conditions that triggers the UE 102 to connect to the C-SN 106A via a particular C-PSCell configured in a particular C-SN configuration. The MN 104A can generate corresponding MN configuration(s) 1, . . . , M₁, based on the parameters received in the CG-Config IE(s) 1, . . . , M₁, to coordinate with the C-SN configuration(s) 1, . . . , M₁, respectively. In some implementations, the MN 104A can generate MN message(s) or RRC container message(s) (e.g., RRCConnectionReconfiguration messages or RRCReconfiguration messages) 1, . . . , M₁ including the C-SN configuration(s) and/or the corresponding MN configuration(s) 1, . . . , M₁, respectively. The MN 104A generates condRRCReconfig field(s)/IE(s) 1, . . . , M₁ to include the MN message(s) or RRC container message(s) 1, . . . , M₁, respectively. The MN 104A generates conditional (re)configuration field(s)/IE(s) (e.g., CondReconfigToAddMod field(s)/IE(s)) 1, . . . , M₁ including the condRRCReconfig field/IE 1, . . . , M₁, the configuration ID(s) (e.g., condReconfigId) 1, . . . , M₁, and the triggering condition configurations (e.g., condExecutionCond) 1, . . . , M₁, respectively. The MN 104A transmits 308 a RRC reconfiguration message including the conditional (re)configuration fields/IEs 1, . . . , M₁ to the UE 102. For example, the RRC reconfiguration message is a RRCConnectionReconfiguration message or RRCReconfiguration message. In some implementations, the MN 104A can generate a first list (e.g., CondReconfigToAddModList) of the conditional (re)configuration field/IEs (e.g., CondReconfigToAddMod). The MN 104A transmits 308 the RRC reconfiguration message including the first list to the UE 102.

In some implementations, the MN 104A includes the reference C-SN configuration in the RRC reconfiguration message in the event 308. In other implementations, the MN 104A includes the reference C-SN configuration in a separate RRC reconfiguration message other than the RRC reconfiguration message of the event 308 and transmits the separate RRC reconfiguration message to the UE 102. In some implementations, the MN 104A includes the reference C-SN configuration in the first list. In other implementations, the MN 104A does not include the reference C-SN configuration in the first list but in a separate field/IE in the RRC reconfiguration message of the event 308. In response, the UE 102 transmits 312 an RRC reconfiguration complete message (e.g., RRCConnectionReconfigurationComplete message or RRCReconfigurationComplete message) to the MN 104A. The events 308 and 312 collectively define an RRC reconfiguration procedure 310.

In some implementations, based on the determination to perform continuous CPAC, the MN 104A determines to configure additional N-1 C-SNs for the UE 102, N is a positive integer larger than 1. In such cases, the C-SN 106A is the first C-SN (i.e., C-SN 1) among the total N C-SNs. The interactions between the MN 104A and the C-SN 2, . . . , N, are similar to the interactions between the MN 104A and the C-SN 1 as described above for the events 304, 306, 308 and 310. If the C-SN 1 (i.e., C-SN 106A) includes a reference C-SN configuration in the SN Addition Request Acknowledge message 306 for the MN 104A as describe above, the MN 104A can include the reference C-SN configuration in SN Addition Request messages that the MN 104A transmits to the C-SN(s) 2, . . . , N, respectively. Each of the C-SN(s) 2, . . . , N, therefore generates C-SN configuration(s) based on the reference C-SN configuration. In some implementations, each of the C-SN configuration(s) is a delta configuration augmenting the reference C-SN configuration.

In some implementations, for each of the N-1 C-SN(s), the MN 104A performs an RRC reconfiguration procedure with the UE 102 similar to the event 310. In other implementations, the MN 104A includes the C-SN configuration(s) received from the N-1 C-SN(s) in the RRC reconfiguration message of the event 308 similar to including the C-SN configuration(s) 1, . . . , M₁ as described above. In some implementations, the MN 104A can manage the C-SN configurations from the N C-SNs for the UE 102 as below. Assumes that there are M₁ C-SN configurations from the C-SN 1, M₂ C-SN configurations from the C-SN 2, . . . , and MN C-SN configurations from the C-SN N, where Mᵢ is a positive integer and i is a number between 1 to N. The MN 104A, for example, can assign configuration ID 1, . . . , M₁ to the M₁ C-SN configurations from the C-SN 1 (and the corresponding MN configurations), configuration ID (M₁+1), . . . , (M₁+M₂) to the M₂ C-SN configurations from the C-SN2 (and the corresponding MN configurations), . . . , and configuration ID (M)+M₂+ . . . +M_{N-1}+1), . . . , (M₁+M₂+ . . . +M_{N}) to the MN C-SN configurations from the C-SN N (and the corresponding MN configurations). The MN 104A transmits the (M₁+M₂+ . . . +M_{N}) C-SN configurations (and the corresponding MN configurations) in one or more conditional configuration lists (e.g., CondReconfigToAddModList) to the UE 102. For example, the MN 104A transmits the C-SN configurations with configuration ID 1, . . . , M₁, in a first CondReconfigToAddModList and transmits the C-SN configurations with configuration ID (M₁+1), . . . , (M₁+M₂+ . . . +M_{N}) in a second CondReconfigToAddModList to the UE 102.

After receiving 312 the RRC reconfiguration complete message or an acknowledgement (e.g., RLC acknowledgement or hybrid automatic repeat request (HARQ) acknowledgement) for a PDU (e.g., RLC PDU or MAC PDU) including the RRC reconfiguration message 308, the MN 104A can (determine to) send 314 an Early Status Transfer message to the C-SN 106A and/or C-SN(s) 2, . . . , N to transfer a COUNT value of the first downlink SDU that the MN 104A forwards to the C-SN 106A and/or C-SN(s) 2, . . . , N or a COUNT value for discarding of already forwarded downlink SDUs for each of DRB(s) of the UE 102. The Early Status Transfer message may be an Early Sequence Number (SN) Status Transfer message, where “SN” in this context refers to sequence number rather than secondary node. The MN 104A can send 314 the Early Status Transfer message without receiving an interface message indicating the UE 102 connects to the C-SN 106A and/or N-1 C-SN(s).

The UE 102 may use the one or more conditions to determine whether to connect to the one of the C-PSCell(s). If the UE 102 detects 316 that a condition for connecting to a first C-PSCell (e.g., the C-PSCell 1 of the C-SN 106A) is satisfied, the UE 102 connects to the first C-PSCell. That is, the condition (i.e., “triggering condition”) triggers the UE 102 to connect to the first C-PSCell or to execute the C-SN configuration concerning the first C-PSCell. However, if the UE 102 does not detect that the condition is satisfied, the UE 102 does not connect to the first C-PSCell. In response to the detection, the UE 102 initiates a random access procedure on the first C-PSCell. In response to the initiation, the UE 102 performs 318 the random access procedure with the C-SN 106A via the first C-PSCell (e.g., the cell 126A). In response to the detection or initiation 316, the UE 102 sends 320 an RRC reconfiguration complete message to the MN 104A. The UE 102 can send 320 the RRC reconfiguration complete message before, during or after the random access procedure.

In some implementations, the UE 102 may indicate, in the RRC reconfiguration complete message, that the UE 102 has executed one of the C-SN configuration(s) by including a configuration ID corresponding to the particular C-SN configuration. The MN 104A can use the configuration ID to identify or determine the ID of the C-PSCell (e.g., the PCI and/or the CGI of the C-PSCell 126A) and/or the C-SN if the MN 104A performs multiple CPA procedures with different C-SNs. The MN 104A can also use the configuration ID to identify or determine the C-SN configuration or the CG-Config IE including the C-SN configuration.

In response to or after receiving 320 the RRC reconfiguration complete message, the MN 104A can send 322 a SN message to the C-SN 106A. In some implementations, the SN message can be a SgNB Reconfiguration Complete or S-Node Reconfiguration Complete message. In other implementations, the SN message can be an RRC Transfer message. In yet other implementations, the SN message can be a new interface message (e.g., XnAP or X2AP message) defined in 3 GPP 38.423 or 36.423 release 17 or future specifications. In some implementations, the UE 102 can include an SN RRC message (e.g., RRCReconfigurationComplete message) in the RRC reconfiguration complete message that the UE 102 transmits at event 320. In such cases, the MN 104A can include the SN RRC message in the SN message.

In some implementations, the random access procedure can be a four-step random access procedure or a two-step random access procedure. In other implementations, the random access procedure can be a contention-based random access procedure or a contention-free random access procedure. For example, the UE 102 may include an RRC reconfiguration complete message in a message 3 of the four-step random access procedure or in a message A of the two-step random access procedure.

After the C-SN 106A successfully completes the random access procedure with the UE 102, the C-SN 106A may transmit 324 an interface message (e.g., SN Modification Required message, an NG-RAN node Configuration Update message, a E-UTRA—NR Cell Resource Coordination Request message, or a success indication message), which may include PSCell information of the PSCell (e.g., cell 126A) and/or the corresponding CG-Config IE and/or coordination information (e.g., SgNB Resource Coordination Information IE or MR-DC Resource Coordination Information IE) for Physical Resource Block (PRB) coordination to the MN 104A. The PSCell information can include a cell global identity (CGI), a physical cell identity (PCI), and/or an absolute radio frequency channel number (ARFCN) identifying a DL carrier frequency of the PSCell. In some implementations, the C-SN 106A can send 324 the interface message in response to or after receiving the SN message or performing 318 the random access procedure. In some implementations, the interface message further includes SN restriction information. The MN 104A may use the SN restriction information to determine the MN restriction information.

In response to or after receiving 320 the RRC reconfiguration complete message or 324 the interface message, the MN 104A applies 326 the corresponding conditional MN configuration. In response to applying 326 the corresponding conditional MN configuration, the MN 104A may transmit 328 an RRC reconfiguration message including configuration parameters to the UE 102. In some implementations, the configuration parameters 328 may reconfigure or release (values) of configuration parameters that the UE 102 uses to communicate with the MN 104A. In other implementations, the configuration parameters 328 may be new configuration parameters to configure the UE 102 to communicate with the MN 104A. In response to the RRC reconfiguration message 328, the UE 102 can transmit 330 an RRC reconfiguration complete message to the MN 104A. The MN 104A may in response transmit 332 an SN Modification Confirm message (e.g., SgNB Modification Confirm or S-Node Modification Confirm message).

In response to or after receiving 320 the RRC reconfiguration complete message or 324 the interface message, the MN 104A can send 334 an SN Status Transfer message to transfer uplink PDCP SN and HFN receiver status and/or downlink PDCP SN and HFN transmitter status for each of DRB(s) of the UE 102. In contrast to event 314, the MN 104A sends 334 a (non-early) SN Status Transfer message.

After the UE 102 successfully completes the 318 the random access procedure, the UE 102 communicates 336 with the MN 104A in accordance with the (updated) MN configuration and with the C-SN 106A via the first C-PSCell in accordance with the C-SN configuration configuring the first C-PSCell. The events 318, 320, 322, 324, 326, 328, 330, 332, 334 and 336 are collectively referred to in FIG. 3A as a CPAC execution procedure 394. The UE 102 can at a later time detect 338 that a condition for connecting to a second C-PSCell belonging to the C-SN 106A is met, similar to event 316. The UE 102, MN 104A, and C-SN 106A can therefore perform 395 a CPAC execution procedure for the second C-PSCell, similar to the procedure 394. If an additional C-SN (e.g., C-SN 2) is configured by the MN 104A, the UE 102 can at a later time (or before the event 338 instead) detect that a condition for connecting to a C-PSCell belonging to the C-SN 2 is met similar to the event 316 or 338. The UE 102, MN 104A, and the C-SN can therefore performs a CPAC execution procedure for the C-PSCell of the C-SN 2, similar to the event 394 or 395.

With continued reference to FIG. 3A, the C-SN configuration in some implementations can be a complete and self-contained configuration (i.e., a full configuration). The C-SN configuration may include a full configuration indication (an information element (IE) or a field) that identifies the C-SN configuration as a full configuration. The UE 102 in this case can use the C-SN configuration to communicate with the SN 106A without relying on an SN configuration. In other implementations, the C-SN configuration can include a “delta” configuration, or one or more configurations that augment the reference C-SN configuration. In these cases, the UE 102 can use the delta C-SN configuration together with the reference C-SN configuration to communicate with the C-SN 106A.

The C-SN configuration can include multiple configuration parameters for the UE 102 to apply when communicating with the SN 106A via a C-PSCell 126A. The multiple configuration parameters may configure the C-PSCell 126A and zero, one, or more candidate secondary cells (C-SCells) of the SN 106A to the UE 102. The multiple configuration parameters may configure radio resources for the UE 102 to communicate with the C-SN 106A via the C-PSCell 126A and zero, one, or more C-SCells of the C-SN 106A. The multiple configuration parameters may configure zero, one, or more radio bearers. The one or more radio bearers can include an SRB and/or one or more DRBs.

In some implementations, the C-SN configuration can include a cell group configuration (CellGroupConfig) IE that configures the C-PSCell 126A and zero, one, or more C-SCells of the C-SN 106A. In one implementation, the C-SN configuration includes a radio bearer configuration. In another implementation, the C-SN configuration does not include a radio bearer configuration. For example, the radio bearer configuration can be a RadioBearerConfig IE, DRB-ToAddModList IE or SRB-ToAddModList IE, DRB-ToAddMod IE or SRB-ToAddMod IE. In various implementations, the C-SN configuration can be an RRCReconfiguration message, RRCReconfiguration-IEs, or the CellGroupConfig IE conforming to 3GPP TS 38.331. The full configuration indication may be a field or an IE conforming to 3GPP TS 38.331. In some implementations, the reference C-SN configuration can include a cell group configuration (CellGroupConfig) IE that configures the C-PSCell 126A and zero, one, or more C-SCells of the C-SN 106A. In one implementation, the reference C-SN configuration includes a radio bearer configuration. In another implementation, the reference C-SN configuration does not include a radio bearer configuration. In various implementations, the reference C-SN configuration can be an RRCReconfiguration message, RRCReconfiguration-IEs, or the CellGroupConfig IE conforming to 3GPP Technical Specification (TS) 38.331.

Alternatively, the reference C-SN configuration is a new field or IE including the RRCReconfiguration message, RRCReconfiguration-IEs, or CellGroupConfig IE in a 3GPP release 18 or later release specification (e.g., TS 38.331). The full configuration indication may be a field or an IE conforming to 3GPP TS 38.331.

In some implementations, the MN 104A determines to update the reference C-SN configuration (i.e., a first reference C-SN configuration). In response to the determination, the MN 104A transmits a second reference C-SN configuration to the UE 102, similar to the procedure 310. In cases where the second reference C-SN configuration is a full configuration, the UE 102 replaces the first reference C-SN configuration with the second reference C-SN configuration. In case that a condition for connecting to a C-PSCell is met, similar to the event 316 or 338, the UE 102 performs a random access procedure on the C-PSCell and applies the C-SN configuration configuring or associated with the C-PSCell and the second reference C-SN configuration, similar to the events 318 and the event 336, 394, or 395, respectively.

In cases where the reference C-SN configuration is a delta configuration, the UE 102 augments the first reference C-SN configuration with the second reference C-SN configuration to obtain an updated reference C-SN configuration. In case that a condition for connecting to a C-PSCell is met, similar to the event 316 or 338, the UE 102 performs a random access procedure on the C-PSCell and applies the C-SN configuration (configuring or associated with the C-PSCell) and the updated reference C-SN configuration, similar to the event 318 and the event 336, 394, or 395, respectively.

After the UE 102 applies the C-SN configuration as described above, the applied C-SN configuration becomes a SN configuration (i.e., serving or source SN configuration) or a portion of the SN configuration. After (e.g., in response to) applying the C-SN configuration, the UE 102 refrains from removing the conditional (re)configuration field(s)/IE(s) associated with the reference C-SN configuration.

In some implementations, the MN 104A can obtain a C-SN configuration configuring a particular C-PSCell for non-continuous CPAC (e.g., Release 17 CPAC) from a C-SN, and transmits the C-SN configuration to the UE 102, similar to the events 304, 306 and 310. In such cases, the C-SN configuration for non-continuous CPAC is not associated with a reference C-SN configuration. In case that a condition for connecting to the particular C-PSCell is met, similar to the event 316 or 338, the UE 102 performs a random access procedure on the particular C-PSCell and applies the C-SN configuration to communicate with the C-SN on the particular C-PSCell, similar to the event 318 and the event 336, 394, or 395, respectively. After applying the C-SN configuration, the UE 102 removes the conditional (re)configuration field(s)/IE(s).

In some implementations, the triggering condition configuration 1 configuring the condition for evaluation and detection in the event 316 for CPA. In the event 308, the UE 102 receives an additional triggering condition configuration for the C-SN configuration to be applied in the event 336 for CPC. After the UE 102 detects that the condition is met in the event 316 or applies the C-SN configuration in the event 336, the UE 102 replaces the triggering condition configuration 1 with the additional triggering condition configuration. While communicating with the SN 106A in the event 336, the UE 102 evaluates whether a condition configured in the additional triggering condition is met.

FIG. 3B depicts a scenario 300B, i.e., an MN-initiated conditional SN Change for continuous CPC, similar to FIG. 3A. The differences between FIG. 3B and FIG. 3A are described below.

The UE 102 initially operates 301 in DC with MN 104A and S-SN 106B and communicates with S-SN 106B via a PSCell 126B in accordance with a first SN configuration (i.e., current SN configuration, serving SN configuration or source SN configuration). At a later time, the MN 104A determines to perform a conditional SN change (preparation) procedure with the C-SN 106A for continuous CPC.

Unlike the scenario 300A in FIG. 3A, where the reference C-SN configuration can be from the C-SN 0, the MN 104A, or the C-SN 1, the MN 104A obtains a reference C-SN configuration from the S-SN 106B in the scenario 300B. More particularly, the MN 104A transmits 340 an SN Modification Request message to the S-SN 106B to query a reference C-SN configuration using a specific IE (e.g., SCG Configuration Query or a new defined IE specifically for continuous CPAC such as a Reference C-SN Configuration Query). The S-SN 106B in response transmits 342 an SN Modification Request Acknowledge message including the reference C-SN configuration to the MN 104A. In some implementations, the reference C-SN configuration is the first SN configuration. In other implementations, the reference C-SN configuration is different from the first SN configuration. In yet other implementations, the reference C-SN configuration is a subset of the first SN configuration. In some implementations, the reference C-SN configuration is a full configuration. In other implementations, the reference C-SN configuration is a delta configuration that augments the first SN configuration.

The MN 104A transmits 305 an SN Addition Request message to the C-SN 106A, similar to the event 304, and including the reference C-SN configuration obtained in the event 342 from the S-SN 106B. The C-SN 106A in response transmits 307 an SN Addition Request Acknowledge message to the MN 104A including M₁ C-SN configuration(s) based on the reference C-SN configuration, similar to the event 306. In some implementations, each of the M₁ C-SN configuration(s) is a delta configuration augmenting the reference C-SN configuration from the S-SN 106B. In some implementations, the C-SN 106A refrains from including a reference C-SN configuration in the SN Addition Request Acknowledge message in the event 307. The MN 104A performs 310 RRC reconfiguration procedure with the UE 102. In cases where early data forwarding is needed, the MN 104A may transmit 344 an Interface message (e.g., Xn-U Address Indication or Data Address Indication message) to the S-SN 106B. The S-SN 106B then transmits 346 an Early Status Transfer message to the MN 104A and the MN 104A then transmits 314 an Early Status Transfer message to the C-SN 106A.

In some implementations, based on the determination to perform continuous CPAC, the MN 104A also determines to configure additional N-1 C-SN(s) for the MN-initiated CPC, as described in FIG. 3A. N is a positive integer larger than 1. The interactions between the MN 104A, the C-SN 2, . . . , N, and the UE 102 are similar to the interactions between the MN 104A, the C-SN 1 and the UE 102 as described above for the events 305, 307, and 310 and as described in FIG. 3A.

Similar to FIG. 3A, the UE 102 later detects 316 that a condition for connecting to the first C-PSCell is met and performs a random access procedure on the first C-PSCell in response to the detection with the C-SN 106A. The UE 102, MN 104A, and C-SN 106A perform the CPAC execution procedure 394. After (e.g., in response to) the procedure 394, the MN 104A transmits 348 an SN Release Request message (e.g., SgNB Release Request or S-Node Release Request message) for the UE 102 to the S-SN 106B. The S-SN 106B in response stops communicating with the UE 102 and transmits 350 an SN Release Request Acknowledge message (e.g., SgNB Release Request Acknowledge or S-Node Release Request Acknowledge message) to the MN 104A. In some implementations, if the S-SN 106B has prepared a C-SN configuration for continuous CPAC, the MN 104A can include, in the SN Release Request message, an indicator or a cause value indicating that the SN Release procedure concerns continuous CPAC. The S-SN 106B therefore does not expect a follow-up UE Context Release procedure from the MN 104A (i.e., the MN 104A does not transmit a UE Context Release message to the S-SN 106B after the SN Release Request message). Upon receiving the SN Release Request message, indicator or cause value, the S-SN 106B keeps the UE context and/or the UE-associated signaling connections between MN 104A and S-SN 106B for UE 102. In cases where data forwarding is needed, the MN 104A can transmit 351 an Interface message (e.g., Xn-U Address Indication or Data Address Indication message) to the S-SN 106B. The S-SN 106B then can transmit 352 an SN Status Transfer message to the MN 104A and the MN 104A then can transmit 334 an SN Status Transfer message to the C-SN 106A. In some implementations, for example, if the S-SN 106B has not prepared a C-SN configuration for continuous CPAC, the MN 104A transmits 356 a UE Context Release message to the S-SN 106B. The events 348, 350, 351, 352, 334, and 356 can be collectively referred to as an SN Release and SN Status Transfer procedure 396.

FIG. 3C depicts a scenario 300C, i.e., an SN-initiated conditional SN change for continuous CPC, similar to FIGS. 3A and 3B. The differences between FIG. 3C and FIGS. 3A and 3B are described below. The S-SN 106B at some time point determines to initiate a conditional SN change (preparation) procedure for one or more C-SNs for continuous CPC. The S-SN 106B can make this determination based on measurement result(s) from the UE 102, for example. In some implementations, the UE 102 performs measurements on cells of the one or more C-SNs and transmits the measurement result(s) to the S-SN 106B in accordance with a measurement configuration in the first SN configuration. In response to the determination, the S-SN 106B transmits 303 an SN Change Required message including a Target SN ID of the C-SN 106A, a CG-Config IE for the C-SN 106A, and a reference C-SN configuration. In some implementations, the S-SN 106B includes, in the SN Change Required message, CPC information for the C-SN 106A. For example, the CPC information (e.g., Conditional PSCell Change Information Required IE) includes an IE indicating the maximum number of PSCells that the C-SN 106A may prepare. In such cases, the S-SN 106B includes the CG-Config IE in the CPC information. The reference C-SN configuration in the SN Change Required message 303, is similar to the reference C-SN configuration in the event 342. In some implementations, the S-SB 106B includes the reference C-SN configuration in the CG-Config IE. In other implementations, the S-SN 106B includes the reference C-SN configuration in a X2AP/XnAP IE of the SN Change Required message, different from an X2AP/XnAP IE that carries the CG-Config IE. In some implementations, the SN Change Required message includes a second indication (e.g., Selective Activation Indication IE) for continuous CPC for the UE 102. In some implementations, the S-SN 106B includes, in the CG-Config IE, triggering condition configuration(s) configuring the condition for the UE 102 to detect in the event 316.

After receiving the SN Change Required message, the MN 104A transmits 305 a SN Addition Request message to the C-SN 106A, similar to the event 304. In the scenario 300A and 300B, the MN 104A derives an ID of the C-SN 106A based on the measurement results (received from the UE 102) and association information preconfigured in the MN 104A. For example, the association information indicates which cell is associated with which base station. In the scenario 300C, the MN 104A transmits the SN Addition Request message 305 to the C-SN 106A based on the Target SN ID of the C-SN 106A. In some implementations, the MN 104A generates an inter-node RRC message (i.e., CG-ConfigInfo IE) based on the CG-Config IE and includes the CG-ConfigInfo IE in the SN Addition Request message. In some implementations, the CG-Config IE includes 1) a candidateCellInfoListSN IE including the measurement results for one or more cells (e.g., cell(s) 126A and/or 126C) of the C-SN 106A and/or 2) a candidateCellListCPC IE indicating one or more cells (e.g., cell(s) 126A and/or 126C) that the S-SN 106B proposes for the C-SN 106A to consider as C-PSCell(s). The MN 104A includes the candidateCellInfoListSN IE and/or candidateCellListCPC IE in the CG-ConfigInfo IE. In some implementations, the CG-Config IE includes triggering condition configuration(s) (e.g., CondReconfigExecCondSCG IE(s)) for connecting the one or more cells. Alternatively, the MN 104A includes the triggering condition configuration(s) in a separate X2AP/XnAP IE of the SN Addition Request message. In other implementations, the MN 104A refrains from including the triggering condition(s) in the SN Addition Request message.

In some implementations, the MN 104A includes the reference C-SN configuration in the SN Addition Request message in the event 305, as described for the event 304. In some implementations, the MN 104A includes a first indication (e.g., Selective Activation Indication IE) for continuous CPAC in the SN Addition Request message in the event 305 based on or in response to the second indication. In some implementations, if the MN 104A does not support the SN-initiated conditional SN change (preparation) procedure for continuous CPC and receives a SN Change Required message for continuous CPAC from a SN (e.g., the SN Change Required message in the event 303), the MN 104A can transmit a SN Change Refuse message to the SN, (e.g., the S-SN 106B). In such cases, the MN 104A can support the SN-initiated conditional SN change (preparation) procedure for non-continuous CPC (e.g., 3GPP Release 17 CPC).

In some implementations, the S-SN 106B is allowed to initiate such conditional SN change (preparation) procedure for continuous CPC with the MN 104A because the S-SN 106B can have received an SN Addition Request message or an SN Modification Request message including an indication (e.g., Selective Activation Indication IE) from the MN 104A before or during the event 301. Based on the indication, the S-SN 106B determines that the MN 104A allows the S-SN 106B to initiate a SN-initiated conditional SN change (preparation) procedure for continuous CPC with the MN 104A. Thus, the S-SN 106B determines to transmit or transmits the SN Changed Required message in the event 303. If the S-SN 106B does not receive the indication, the S-SN 106B refrains from initiating a SN-initiated conditional SN change (preparation) procedure for continuous CPC with the MN 104A. In such a case, the S-SN 106B refrains from transmitting a SN Change Required message like the message in the event 303.

The C-SN 106A, in response to the SN Addition Request message, transmits 307 an SN Addition Request Acknowledge message to the MN 104A including M₁ C-SN configuration(s), similar to the event 306. The MN 104A then transmits the M₁ C-SN configuration(s) to the UE 102 in the procedure 310. In some implementations, based on the C-SN configuration, the C-SN 106A generates each of the M₁ C-SN configuration(s) as a delta configuration augmenting the reference C-SN configuration. Unlike the scenarios 300A and 300B, in the RRC reconfiguration message of the procedure 310, each of the conditional (re)configuration field(s)/IE(s) includes the triggering condition configuration received from the S-SN 106B. After receiving the SN Addition Request Acknowledge message or after or while performing the procedure 310 with the UE 102, the MN 104A transmits 309 an SN Change Confirm message to the S-SN 106B.

In some implementations, the Target SN ID(s) include ID(s) of the C-SN(s) 2, . . . , N for the SN-initiated conditional SN change (preparation) procedure for continuous CPC with the C-SN(s) 2, . . . , N. Thus, the MN 104A can transmit a SN Addition Request message to each of the C-SN(s) 2, . . . , N as described above.

Turning to FIGS. 4A-4B, scenarios 400A-400B may each be similar to any one of the scenarios 300A-300C. However, the scenarios 400A-400B involve an intra-base station CPC while the scenarios 300A-300C concern CPA or inter-base station CPC.

FIG. 4A depicts a scenario 400A, i.e., an intra-SN continues CPC. In the scenario 400A the UE 102 initially operates 402 in DC with the MN 104A and SN 106A and communicates with the SN 106A via a PSCell 126B in accordance with a first SN configuration, similar to the event 301.

At a later time, the SN 106A determines to configure C-PSCells 1, . . . , M₁, M₁ is a positive integer to the UE 102 for intra-SN continuous CPC. The SN 106A can make this determination based on measurement result(s) from the UE 102, for example. In some implementations, the UE 102 performs measurements on cells of the SN 106A and transmits the measurement result(s) to the SN 106A in accordance with a measurement configuration in the first SN configuration. In response to the determination, the SN 106A generates a first SN RRC reconfiguration message including the M₁ C-SN configuration(s) (i.e., C-SN configuration(s) 1, . . . , M₁) and/or a reference C-SN configuration, similar to the event 308, and transmits 406 the first SN RRC reconfiguration message to the MN 104A. The C-SN configuration(s) 1, . . . , M₁ configure or are associated with the C-PSCells 1, . . . , M₁, respectively. In some implementations, each of the MI C-SN configuration(s) is a delta configuration augmenting the reference C-SN configuration. In some implementations, the reference C-SN configuration is the first SN configuration. In other implementations, the reference C-SN configuration is different from the first SN configuration. In yet other implementations, the reference C-SN configuration is a subset of the first SN configuration. In some implementations, the reference C-SN configuration is a full configuration. In other implementations, the reference C-SN configuration is a delta configuration that augments the first SN configuration. In some implementations, the SN 106A transmits a SN message (e.g., SN Modification Required message) including the first SN RRC reconfiguration message to the MN 104A in the event 406. The MN 104A in turn transmits 408 the first SN RRC reconfiguration message to the UE 102. The UE 102, in response to the SN RRC reconfiguration message, the UE 102 transmits 412 a first SN RRC reconfiguration complete message to the MN 104A, which in turn transmits 413 the first SN RRC reconfiguration complete message to the SN 106A. In some implementations, the MN 104A can include the first SN RRC reconfiguration complete message in the event 413 in an SN Reconfiguration Complete message.

In some implementations, the MN 104A generates an MN RRC message (e.g., RRC reconfiguration message) including the first SN RRC reconfiguration message and transmits the MN RRC message to the UE 102 in the event 408. In such cases, the UE 102 transmits an MN RRC response message (e.g., RRC reconfiguration complete message) including the first SN RRC reconfiguration complete message to the MN 104A in the event 412 in response to the MN RRC message.

The UE 102 can later detect 416 that a condition for connecting to a first C-PSCell (e.g., the C-PSCell 1) is met. In response to the detection, the UE 102 performs 418 a random access procedure with the SN 106A via the first C-PSCell and transmits 420 a second SN RRC reconfiguration complete message to the MN 104A, which in turn transmits 422 the second SN RRC reconfiguration complete message to the SN 106A. In some implementations, the second SN RRC reconfiguration complete message can include a configuration ID indicating the C-SN configuration 1 for the first C-PSCell to the MN 104A. In some implementations, the UE 102 includes the second SN RRC reconfiguration complete message in an ULInformationTransferMRDC message. In some implementations, the MN 104A transmits a SN message (e.g., RRC Transfer message) including the second SN RRC reconfiguration complete message to the SN 106A in the event 422.

After successfully completing the random access procedure, the UE 102 in DC communicates 436 with the MN 104A and the SN 106A and communicates with the SN 106A via the first C-PSCell in accordance with the C-SN configuration. The events 418, 420, 422, and 436 can be collectively referred to as a (intra-SN) CPC execution procedure 494. The UE 102 can later detect 438 that a condition for connecting to a second C-PSCell is met, similar to the event 418. The UE 102, MN 104A, and SN 106A performs 495 the (intra-SN) CPC execution procedure for the second C-PSCell similar to the event 494.

Referring next to FIG. 4B, a scenario 400B similar to the scenario 400A, except that the SN 106A transmits 409 the first SN RRC reconfiguration message to the UE 102 directly, e.g., via a SRB3, and the UE 102, in response, transmits 411 the first RRC reconfiguration complete message to the SN 106A directly, e.g., via the SRB3. In response to the detection 416, the UE 102 performs 418 the random access procedure with the SN 106A via the first C-PSCell and transmits 421 the second SN RRC reconfiguration complete message to the SN 106A directly, e.g., via the SRB3.

The events 418, 421, 422, and 436 can be collectively referred to as a (intra-SN) CPC execution procedure 496. The UE 102 can later detect 438 that a condition for connecting to a second C-PSCell is met similar to the event 418. The UE 102, MN 104A, and SN 106A perform 497 the (intra-SN) CPC execution procedure for the second C-PSCell, similar to the event 496.

In some implementations, the SN 106A determines to update the reference C-SN configuration (i.e., a first reference C-SN configuration). In response to the determination, the SN 106A transmits a second reference C-SN configuration, similar to the event 408 or 409. In cases where the second reference C-SN configuration is a full configuration, the UE 102 replaces the first reference C-SN configuration with the second reference C-SN configuration. In case that a condition for connecting to a C-PSCell is met, similar to the event 416 or 438, the UE 102 performs a random access procedure on the C-PSCell and applies the C-SN configuration configuring or associated with the C-PSCell and the second C-SN configuration to communicate with the SN 106A, similar to the events 418 and 436, 494, 495, 496, or 497. In cases where the second reference C-SN configuration is a delta configuration, the UE 102 augments the first reference C-SN configuration with the second reference C-SN configuration to obtain an updated reference C-SN configuration. In case that a condition for connecting to a C-PSCell is met similar to event 416 or 438, the UE 102 performs a random access procedure on the C-PSCell and applies the C-SN configuration (configuring or associated with the C-PSCell) and the updated C-SN configuration to communicate with the SN 106A, similar to the event 418 and the event 436, 494, 495, 496, or 497, respectively.

After the UE 102 applies the C-SN configuration as described above, the applied C-SN configuration becomes a SN configuration (i.e., serving or source SN configuration) or a portion of the SN configuration. After (e.g., in response to) applying the C-SN configuration, the UE 102 refrains from removing the conditional (re)configuration field(s)/IE(s) associated with the reference C-SN configuration.

In some implementations, the SN 106A can generate a C-SN configuration configuring a particular C-PSCell for non-continuous CPAC and transmits the C-SN configuration to the UE 102, similar to the events 406 and 408 or the event 409. In such cases, the C-SN configuration for non-continuous CPAC is not associated with a reference C-SN configuration. In case that a condition for connecting to the particular C-PSCell is met, similar to the event 416 or 438, the UE 102 performs a random access procedure on the particular C-PSCell and applies the C-SN configuration to communicate with the SN 106A on the particular C-PSCell, similar to the event 318 and the event 336, 394, or 395, respectively. After applying the C-SN configuration, the UE 102 removes the conditional (re)configuration field(s)/IE(s).

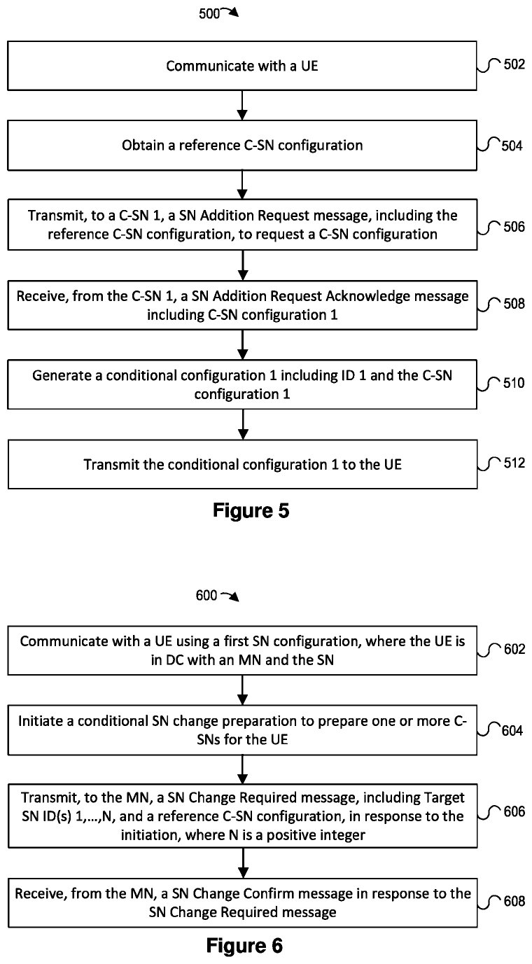

FIGS. 5-12B are flow diagrams depicting example methods that a base station (e.g., the base station 104A, 104B, 106A, or 106B) can implement to support continuous CPAC procedures in accordance with the techniques of this disclosure. As indicated at various points throughout this disclosure, the example methods depicted in FIGS. 5-12B may be implemented during the scenarios 300A-300C and 400A-400B described above.

FIG. 5 illustrates a method 500, which can be implemented by an MN (e.g., the MN 104A), for performing a continuous CPAC procedure with an SN (e.g., the S-SN 106B) for a UE (e.g., the UE 102).

The method 500 begins at block 502, where the MN communicates with a UE (e.g., event 301, or 302). At block 504, the MN obtains a reference C-SN configuration (e.g., event 306, 342, or 303). At block 506, the MN transmits, to a C-SN 1, an SN Addition Request message, including the reference C-SN configuration, to request a C-SN configuration (e.g., event 304, 305). At block 508, the MN receives, from the C-SN 1, an SN Addition Request Acknowledge message including C-SN configuration 1 (e.g., event 306, or 307). The MN at block 510 generates a conditional configuration 1 including ID 1 and the C-SN configuration 1. The MN at block 512 transmits the conditional configuration 1 to the UE (e.g., event 308, or 310).

In some implementations, the MN generates a MN message 1 including the C-SN configuration 1 and includes the ID 1 and the MN message 1 in the conditional configuration 1 at block 510. In some implementations, the MN includes a MN configuration 1 in the MN message 1. In other implementations, the MN does not include a MN configuration in the MN message 1. In some implementations, the UE communicates with the SN using a first SN configuration. In some implementations, the first SN configuration is the same as the reference C-SN configuration. In other implementations, the first SN configuration is different from the reference C-SN configuration. In some implementations, the MN transmits the reference C-SN configuration to the UE. The ID 1 identifies the MN message 1, C-SN configuration 1 or the conditional configuration 1.

In some implementations, the MN generates a list 1 including the conditional configuration 1 and transmits a first message including the list 1 to the UE at block 512. For example, the first message is a RRC reconfiguration message, and the list 1 is an IE/field (e.g., CondReconfigToAddModList).

In some implementations, the MN generates the reference C-SN configuration. In other implementations, the MN obtains the reference C-SN configuration from a SN in the case that the UE operates in DC with the MN and the SN. For example, the MN transmits a SN message (e.g., SN Modification Request message) to the SN to obtain the reference C-SN configuration from the SN. In response, the SN generates the reference C-SN configuration and transmits a SN response message including the reference C-SN configuration to the MN. In some implementations, the SN generates the reference C-SN configuration based on the first SN configuration. In some implementations, the SN generates a first inter-node container (e.g., CG-Config) including the reference C-SN configuration and includes the first inter-node container in the SN response message. The MN generates a second inter-node container (e.g., CG-ConfigInfo) based on the first inter-node container and includes the second inter-node container in the SN Addition Request message to include the reference C-SN configuration at block 506 (e.g., event 305).

In some implementations, the MN can obtain C-SN configuration(s) 2, . . . , N from C-SN(s) 2, . . . , N, respectively. N is an integer and larger than 1. Blocks 506 and 508 are collectively referred to as SN procedure 1. The MN can perform SN procedure(s) 2, . . . , N with C-SN 2, . . . , N to obtain the C-SN configuration(s) 2, . . . , N, respectively, similar to the SN procedure 1. The MN generates conditional configuration(s) 2, . . . , N, including ID(s) 2, . . . , N and C-SN configuration(s) 2, . . . , N, respectively, and transmits the conditional configuration(s) 2, . . . , N to the UE. In some implementations, the MN includes the C-SN configuration(s) 2, . . . , N in MN message(s) 2, . . . , N and includes the MN message(s) 2, . . . , N in the conditional configuration(s) 2, . . . , N, respectively. In some implementations, the MN includes MN configuration(s) 2, . . . , N in the MN message(s) 2, . . . , N, respectively. In some implementations, the MN configuration(s) 1, . . . , N can be the same or different. The ID(s) 2, . . . , N identifies the MN message(s) 2, . . . , N, C-SN configuration(s) 2, . . . , N or the conditional configuration(s) 2, . . . , N, respectively. The ID(s) 1, . . . , N can be configuration ID(s) as described for FIG. 3A.

In some implementations, the MN transmits message(s) including the conditional configuration 1 and conditional configuration(s) 2, . . . , N to the UE. In one implementation, the MN includes the conditional configuration(s) 2, . . . , N in the list 1. In another implementation, the MN generates a list 2 including conditional configuration(s) 2, . . . , N and transmits a second message including the list 2 to the UE. For example, the second message is a RRC reconfiguration message, and the list 2 is an IE/field (e.g., CondReconfigToAddModList).

In some implementations, the MN transmits the reference C-SN configuration to the UE. In one implementation, the MN includes the reference C-SN configuration in the list 1 and does not include the reference C-SN configuration in a conditional configuration in the list 1. In the case that the MN transmits the list 2, the MN does not include the reference C-SN configuration in the list 2.

In some alternative implementations, the MN obtains the reference C-SN configuration from C-SN 0. In such cases, the reference C-SN configuration is a C-SN configuration (e.g., C-SN configuration 0). The MN transmits an SN Addition Request message to the C-SN 0 and receive an SN Addition Request Acknowledge message including the C-SN configuration 0, in response. The MN transmits the C-SN configuration 0 to the UE. The MN generates a conditional configuration 0 including an ID 0 and the C-SN configuration 0, includes the conditional configuration 0 in a list 0, and transmits a third message including the list 0 to the UE.

In some implementations, the reference C-SN configuration is a full configuration. In other implementations, the reference C-SN configuration is a delta configuration which augments the first SN configuration.

The above examples and implementations described for FIG. 5 can also apply to FIGS. 6-12B if there is no conflict.

FIG. 6 illustrates a method 600, which can be implemented by an SN (e.g., the S-SN 106B), for performing a continuous CPAC procedure with an MN (e.g., the MN 104A) for a UE (e.g., the UE 102).

The method 600 begins at block 602, where the SN communicates with the UE using a first SN configuration, where the UE is in DC with an MN and the SN (e.g., event 301). At block 604, the SN at initiates a conditional SN change preparation to prepare one or more C-SNs for the UE. At block 606, the SN transmits, to the MN, an SN Change Required message, including Target SN ID(s) 1, . . . , N, and a reference C-SN configuration, in response to the initiation, where N is a positive integer (e.g., event 303). At block 608, the S-SN receives, from the MN, an SN Change Confirm message (e.g., event 309) in response to the SN Change Required message.

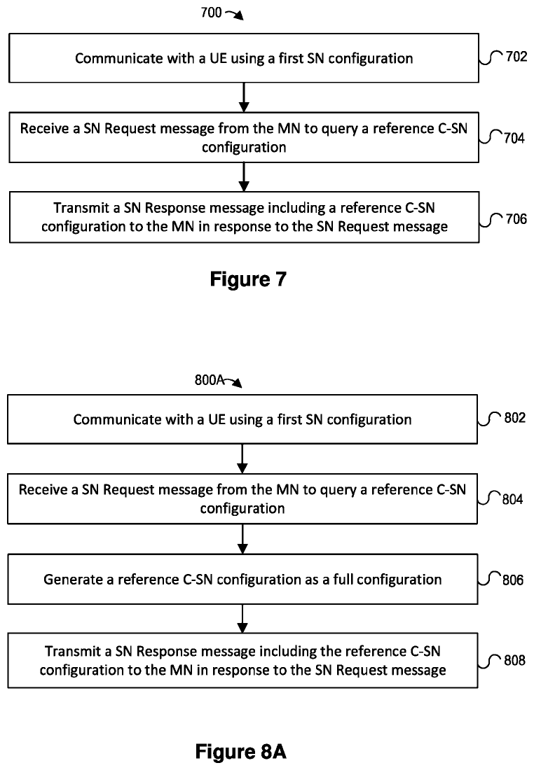

FIG. 7 illustrates a method 700, which can be implemented by an SN (e.g., the S-SN 106B), for performing a continuous CPAC procedure with an MN (e.g., the MN 104A) for a UE (e.g., the UE 102).

The method 700 begins at block 702, where the SN communicates with the UE using a first SN configuration (e.g., event 301). At block 704, the SN receives an SN Request message from the MN to query a reference C-SN configuration (e.g., event 340). At block 706, the SN transmits an SN Response message including a reference C-SN configuration to the MN in response to the SN Request message (e.g., event 342).

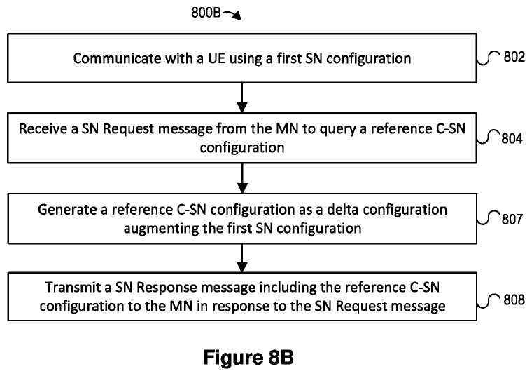

FIG. 8A illustrates a method 800A, which can be implemented by an SN (e.g., the S-SN 106B), for performing a continuous CPAC procedure with an MN (e.g., the MN 104A) for a UE (e.g., the UE 102).

The method 800A begins at block 802, where the SN communicates with the UE using a first SN configuration (e.g., event 301). At block 804, the SN receives an SN Request message from the MN to query a reference C-SN configuration (e.g., event 340). At block 806, the SN generates a reference C-SN configuration as a full configuration. At block 806, the SN transmits an SN Response message including the reference C-SN configuration to the MN in response to the SN Request message (e.g., event 342). In some implementations, the SN includes a full configuration indication in the SN Response message to indicate that the reference C-SN configuration is a full configuration. Alternatively, the SN includes a full configuration indication in the reference C-SN configuration to indicate that the reference C-SN configuration is a full configuration.

FIG. 8B illustrates a method 800B similar to the method 800A, except that the method 800B includes block 807 instead of block 808. At block 807, the SN generates a reference C-SN configuration as a delta configuration augmenting the first SN configuration. In some implementations, the SN includes a delta configuration indication in the SN Response message to indicate that the reference C-SN configuration is a delta configuration. Alternatively, the SN includes a delta configuration indication in the reference C-SN configuration to indicate that the reference C-SN configuration is a delta configuration.

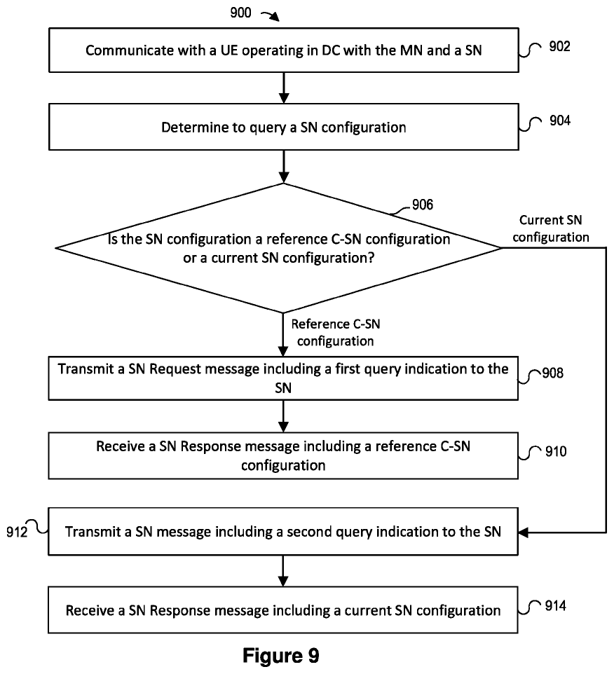

FIG. 9 illustrates a method 900, which can be implemented by an MN (e.g., the MN 104A), for obtaining an SN configuration for a UE (e.g., the UE 102).

The method 900 begins at block 902, where the MN communicates with a UE operating in DC with the MN and an SN. At block 904, the MN determines to query an SN configuration. At block 906, the MN determines to query a SN configuration. If the SN configuration to be queried is a reference C-SN configuration, the flow proceeds to block 908 where the MN transmits an SN Request message including a first query indication (e.g., Reference C-SN Configuration Query IE or Selective Activation Indication IE) to the SN (e.g., event 340). The flow further proceeds to block 910 where the MN receives an SN Response message including a reference C-SN configuration (e.g., event 342). If the SN configuration to be queried is a current SN configuration, the flow proceeds to block 912 where the MN transmits an SN Request message including a second query indication (e.g., SCG Configuration Query IE) to the SN (e.g., event 340). The flow further proceeds to block 914 where the MN receives an SN Response message including a current SN configuration (e.g., event 342).

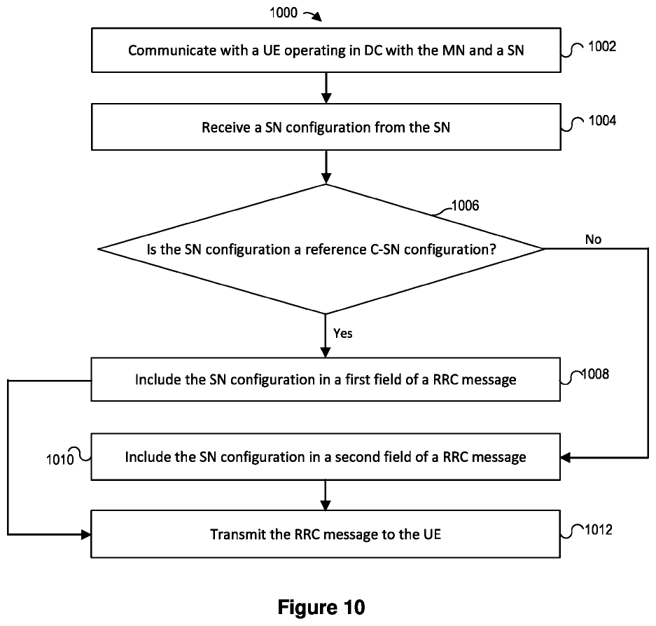

FIG. 10 illustrates a method 1000, which can be implemented by an MN (e.g., the MN 104A), for transmitting an SN configuration to a UE (e.g., the UE 102).

The method 1000 begins at block 1002, where the MN communicates with a UE operating in DC with the MN and an SN. At block 1004, the MN receives an SN configuration from the SN (e.g., event 342, 303, or 307). At block 1006, the MN determines whether the SN configuration is a reference C-SN configuration. If the MN determines that the SN configuration is a reference C-SN configuration the flow proceeds to block 1008 where the MN includes the SN configuration in a first field of an RRC message. For example, the first field is a ref-SN-Config field, a ref-C-SN-Config field or a refConfigSCG field. Otherwise, if the MN determines that the SN configuration is not a reference C-SN configuration, the flow proceeds to block 1010 where the MN includes the SN configuration in a second field of an RRC message. For example, the second field is a mrdc-SecondaryCellGroupConfig field or a condRRCReconfig field. The flow further proceeds to block 1012 from block 1008 as well as block 1010. At block 1012, the MN transmits the RRC message to the UE.

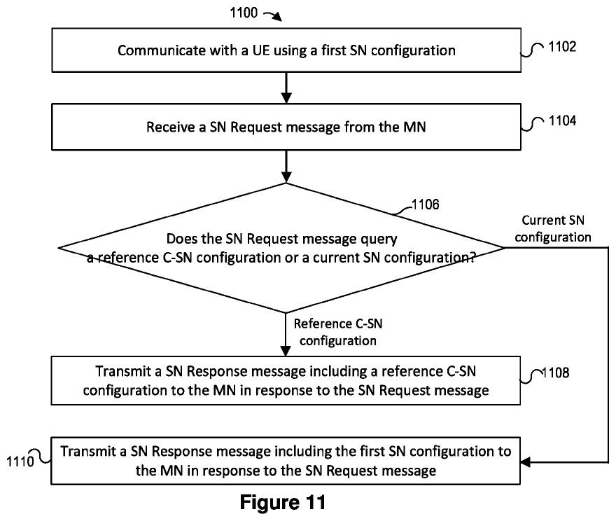

FIG. 11 illustrates a method 1100, which can be implemented by an SN (e.g., the S-SN 106B), for transmitting a SN configuration to a UE (e.g., the UE 102).

The method 1100 begins at block 1102, where the SN communicates with a UE using a first SN configuration (and in DC with a MN and the SN). At block 1104, the SN receives an SN Request message from the MN (e.g., event 340). At block 1106, the SN determines whether the SN Request message queries a reference C-SN configuration or a current SN configuration. If SN determines that the SN Request message queries a reference C-SN configuration, the flow proceeds to block 1108 where the SN transmits a SN Response message including a reference C-SN configuration to the MN in response to the SN Request message (e.g., event 342). Otherwise, if the SN determines that the SN Request message queries a current SN configuration, the flow proceeds to block 1110 where the SN transmits a SN Response message including the first SN configuration to the MN in response to the SN Request message (e.g., event 342).

In some implementations, the SN Request message and SN Response message is a SN Modification Request message and a SN Modification Request Acknowledge message, respectively. In other implementations, the SN Request message and SN Response message is a SN Addition Request message and a SN Addition Request Acknowledge message, respectively.

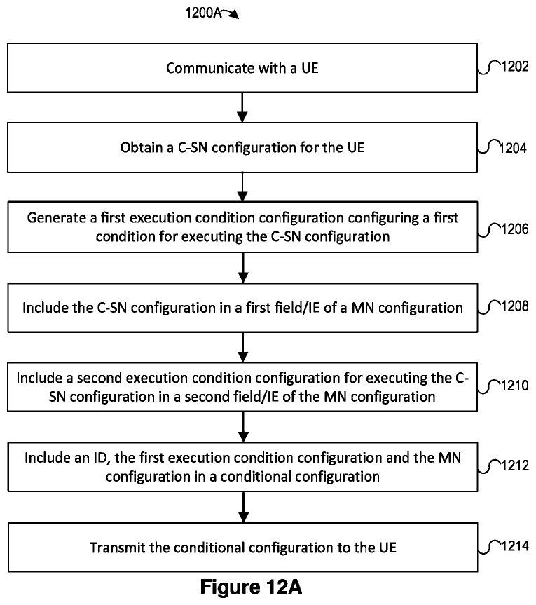

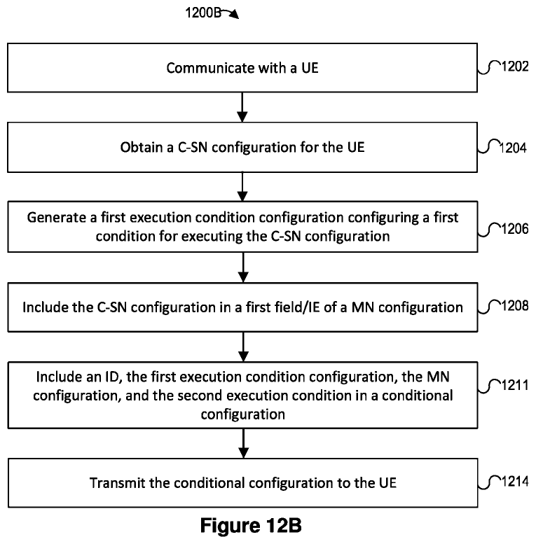

FIG. 12A illustrates a method 1200A, which can be implemented by an MN (e.g., MN 104A), for managing a conditional configuration for a UE (e.g., the UE 102).

The method 1200A begins at block 1202, where the MN communicates with the UE. At block 1204, the MN obtains a C-SN configuration for the UE (e.g., event 306 or 307). At block 1206, the MN generates a first execution condition configuration (e.g., condExecutionCond) configuring a first condition for executing the C-SN configuration. At block 1208, the MN includes the C-SN configuration in a first field/IE of a MN configuration. At block 1210, the MN includes a second execution condition configuration (e.g., CondReconfigExecCondSCG) for executing the C-SN configuration in a second field/IE of the MN configuration. At block 1212, the MN includes an ID, the first execution condition configuration and the MN configuration in a conditional configuration. For example, the ID is a configuration identifying the conditional configuration. At block 1214, the MN transmits the conditional configuration to the UE (e.g., event 308, 310).

In some implementations, the second execution condition configuration is generated by an S-SN and is received by the MN in an SN Required message (e.g., SN Change Required message) from the S-SN (e.g., event 303). In other implementations, the second execution condition configuration is generated by the C-SN and is received by the MN in an SN Addition Request Acknowledge message from the C-SN (e.g., event 306, 307) or a SN Modification Request Acknowledge message (e.g., event 342).

FIG. 12B illustrates a method 1200B similar to the method 1200A, except that the method 1200B includes block 1211 instead of blocks 1210 and 1212. At block 1211, the MN includes an ID, the first execution condition configuration, the MN configuration, and the second execution condition in a conditional configuration. In other words, the second execution condition is not included in the MN configuration but in the same level as the MN configuration in the conditional configuration.

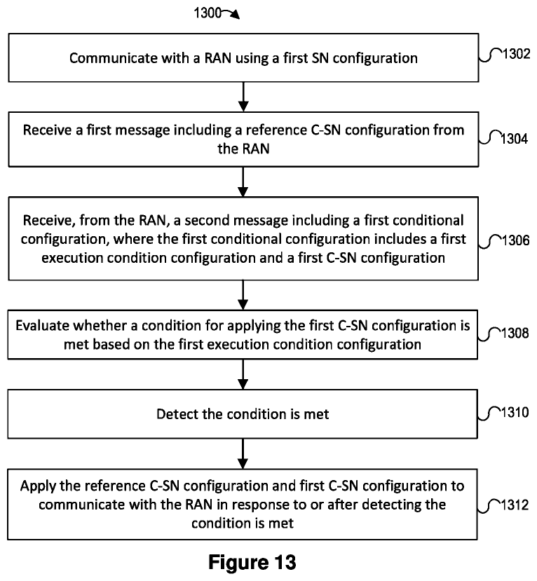

FIG. 13 illustrates a method 1300, which can be implemented by a UE (e.g., the UE 102), for performing a continuous CPAC procedure with a RAN (e.g., the RAN 105, or the base station 104A and/or 106B).

The method 1300 begins at block 1302, where the UE communicates with the RAN using a first SN configuration (e.g., event 301, 302, 401, 402). The UE at block 1304 receives a first message including a reference C-SN configuration from the RAN (e.g., event 308, 310, 408 or 409). At block 1306, the UE receives, from the RAN, a second message including a first conditional configuration, where the first conditional configuration includes a first execution condition configuration and a first C-SN configuration (e.g., event 308, 310, 408, or 409). At block 1308, the UE evaluates whether a condition for applying the first C-SN configuration is met based on the first execution condition configuration. At block 1310, the UE detects the condition is met (e.g., event 316, 338, 416, or 438). At block 1312, the UE applies the reference C-SN configuration and first C-SN configuration to communicate with the RAN in response to or after detecting the condition is met (e.g., event 336, 395, 436, or 495).

In some implementations, the reference C-SN configuration is a full configuration. In other implementations, the reference C-SN configuration is a delta configuration which augments the first SN configuration. In such cases, the UE at block 1312 applies the reference C-SN configuration, first C-SN configuration and at least a portion of the first SN configuration to communicate with the RAN in response to or after detecting the condition is met.

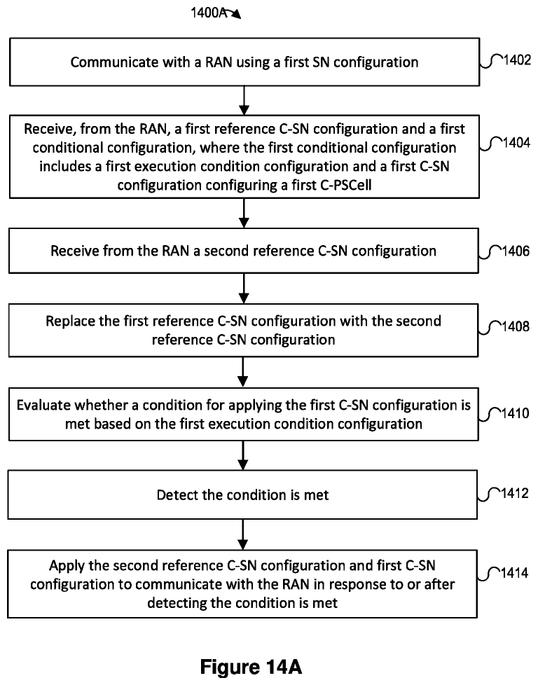

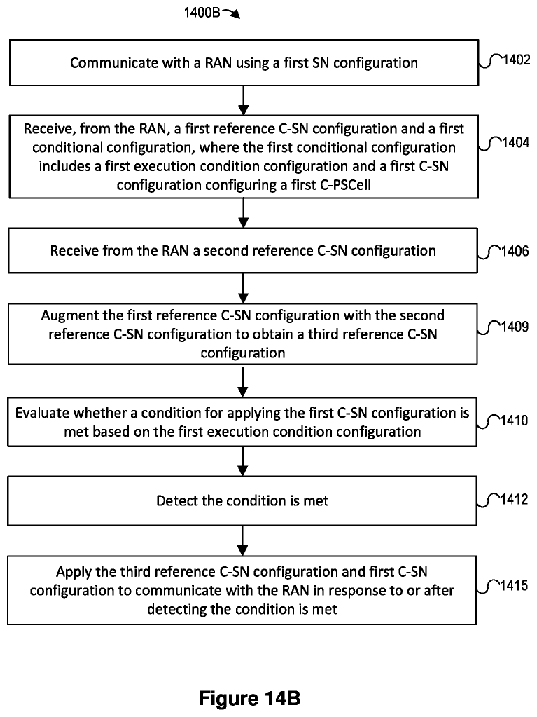

FIG. 14A illustrates a method 1400A, which can be implemented by a UE (e.g., the UE 102), for performing a continuous CPAC procedure with a RAN (e.g., the RAN 105, or the base station 104A and/or 106B).

The method 1400A begins at block 1402, the UE communicates with the RAN using a first SN configuration (e.g., event 301, 302, 401, 402). The UE at block 1404 receives, from the RAN, a first reference C-SN configuration and a first conditional configuration, where the first conditional configuration includes a first execution condition configuration and a first C-SN configuration configuring a first cell (e.g., event 308, 310, 408 or 409). At block 1406, the UE receives, from the RAN, a second reference C-SN configuration (e.g., event 308, 310, 408, or 409). At block 1408, the UE replaces the first reference C-SN configuration with the second reference C-SN configuration. At block 1410, the UE evaluates whether a condition for applying the first C-SN configuration is met based on the first execution condition configuration. At block 1412, the UE detects the condition is met (e.g., event 316, 338, 416, or 438). At block 1414, the UE applies the second reference C-SN configuration and the first C-SN configuration to communicate with the RAN in response to or after detecting the condition is met (e.g., event 336, 395, 436, or 495).

FIG. 14B illustrates a method 1400B similar to the method 1400A, except that the method 1400B includes blocks 1409 and 615 instead of blocks 1408 and 1414. At block 1409, the UE augments the first reference C-SN configuration with the second reference C-SN configuration to obtain a third reference C-SN configuration. At block 615, the UE applies the third reference C-SN configuration and the first C-SN configuration to communicate with the RAN in response to or after detecting the condition is met (e.g., event 336, 395, 436, or 495).

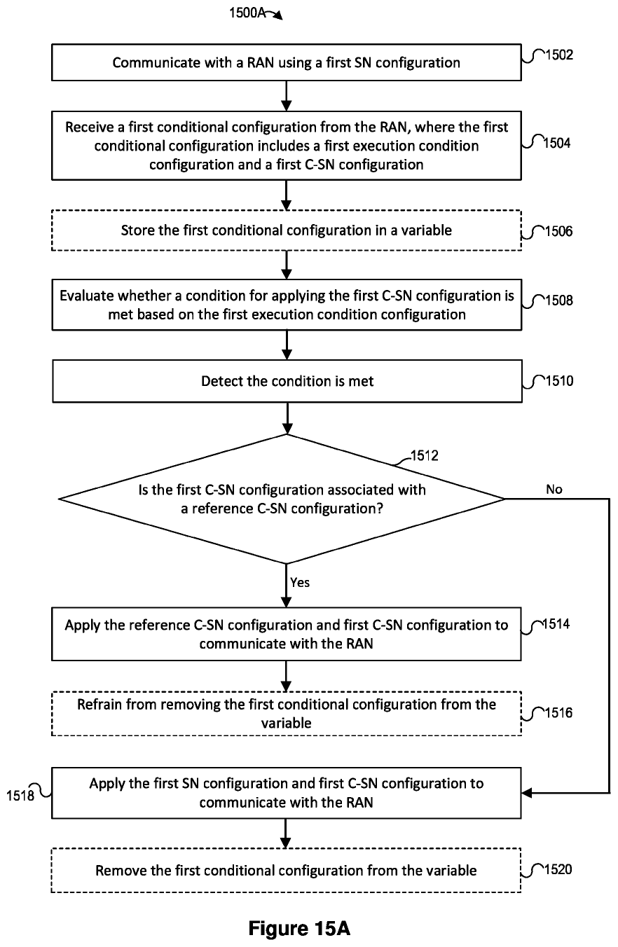

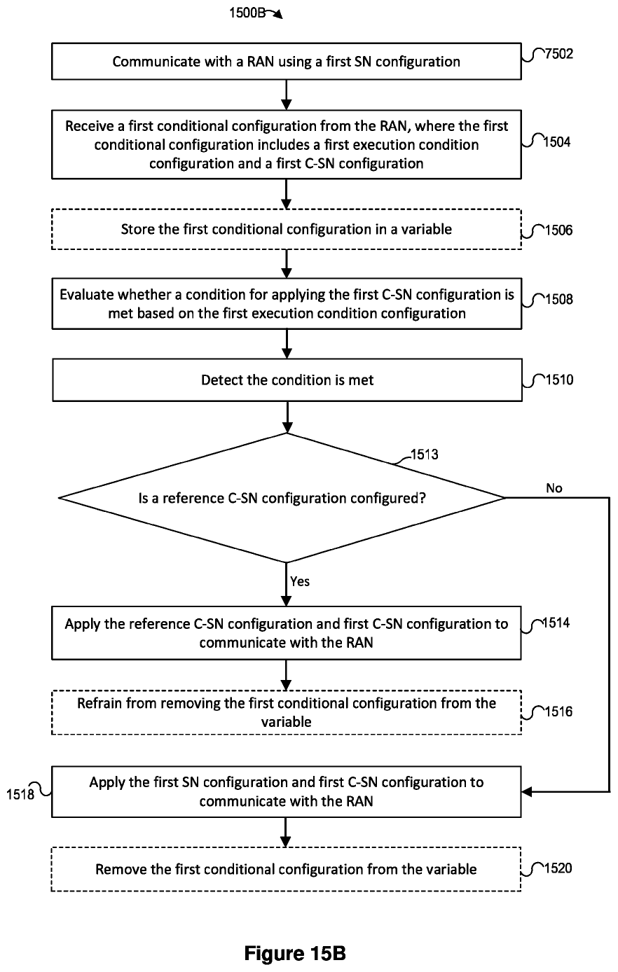

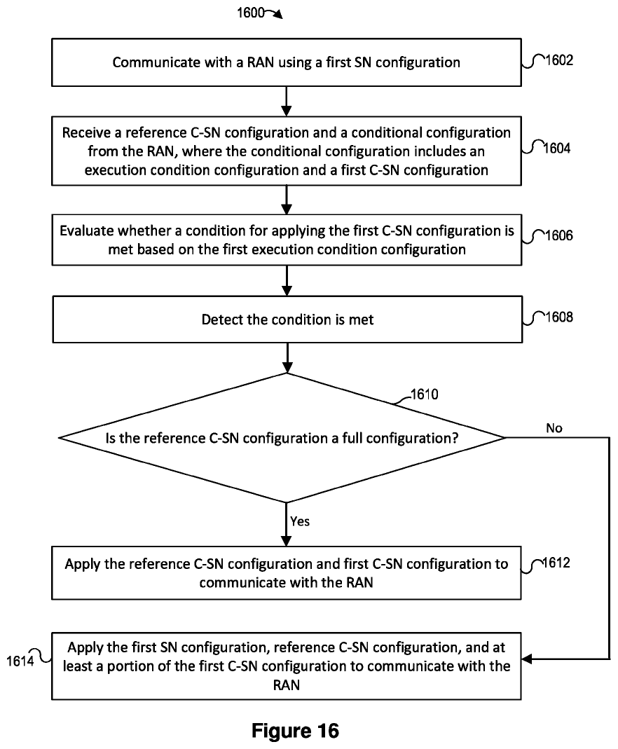

FIG. 15A illustrates a method 1500A, which can be implemented by a UE (e.g., the UE 102), for performing a continuous CPAC procedure with a RAN (e.g., the RAN 105, or the base station 104A and/or 106B).

The method 1500A begins at block 1502, where the UE communicates with the RAN using a first SN configuration (e.g., event 301, 302, 401, 402). The UE at block 1504 receives a first conditional configuration from the RAN, where the first conditional configuration includes a first execution condition configuration and a first C-SN configuration (e.g., event 308, 310, 408 or 409). At block 1506, the UE can store the first conditional configuration in a variable. The UE at block 1508 evaluates whether a condition for applying the first C-SN configuration is met based on the first execution condition configuration. The UE at block 1510 detects the condition is met (e.g., event 316, 338, 416, or 438). At block 1512, the UE determines whether the first C-SN configuration is associated with a reference C-SN configuration. If the UE determines that the first C-SN configuration is associated with a reference C-SN configuration at block 1512, the flow proceeds to block 1514 where the UE applies the reference C-SN configuration and first C-SN configuration to communicate with the RAN (e.g., event 336, 395, 436, or 495). At block 1516 (optional), the UE refrains from removing the first conditional configuration from the variable. Otherwise, if the UE determines that the first C-SN configuration is not associated with a reference C-SN configuration at block 1512, the flow proceeds to block 1518 where the UE applies the first SN configuration and first C-SN configuration to communicate with the RAN (e.g., event 336, 395, 436, or 495). At block 1520 (optional), the UE removes the first conditional configuration from the variable.

In some implementations, if the UE determines that the first C-SN configuration is not associated with a reference C-SN configuration at block 1512, the UE can further determine whether the first C-SN configuration is a full configuration. If the UE determines that the first C-SN configuration is a full configuration, the UE applies the first C-SN configuration to communicate with the RAN and does not apply the first SN configuration (e.g., event 336, 395, 436, or 495). Otherwise, if the determines that the first C-SN configuration is a delta configuration, the UE applies the first SN configuration and first C-SN configuration to communicate with the RAN (e.g., event 336, 395, 436, or 495).

FIG. 15B illustrates a method 1500B similar to 1500A, except that the method 1500B includes block 1513 instead of block 1512. At block 1513, the UE determines whether a reference C-SN configuration is configured. If the UE determines that a reference C-SN configuration is configured, the flow proceeds to block 1514. Otherwise, if the UE determines that a reference C-SN configuration is not configured, the flow proceeds to block 1518.

FIG. 16 illustrates a method 1600, which can be implemented by a UE (e.g., the UE 102), for performing a continuous CPAC procedure with a RAN (e.g., the RAN 105, or the base station 104A and/or 106B).

The method 1600 begins at block 1602, where the UE communicates with the RAN using a first SN configuration (e.g., event 301, 302, 401, 402). The UE at block 1604 receives a reference C-SN configuration and a conditional configuration from the RAN, where the conditional configuration includes an execution condition configuration and a first C-SN configuration (e.g., event 308, 310, 408 or 409). At block 1606, the UE evaluates whether a condition for applying the first C-SN configuration is met based on the first execution condition configuration. The UE at block 1608 detects the condition is met (e.g., event 316, 338, 416, or 438). At block 1610, the UE determines whether the reference C-SN configuration is a full configuration. If the UE determines that the reference C-SN configuration is a full configuration at block 1610, the flow proceeds to block 1612 where the UE applies the reference C-SN configuration and C-SN configuration to communicate with the RAN (e.g., event 336, 395, 436, or 495). Otherwise, if the UE determines that the reference C-SN configuration is not a full configuration at block 1610 (i.e., the reference C-SN configuration is a delta configuration), the flow proceeds to block 1614 where the UE applies the first SN configuration, reference C-SN configuration, and at least a portion of the first C-SN configuration to communicate with the RAN (e.g., event 336, 395, 436, or 495).

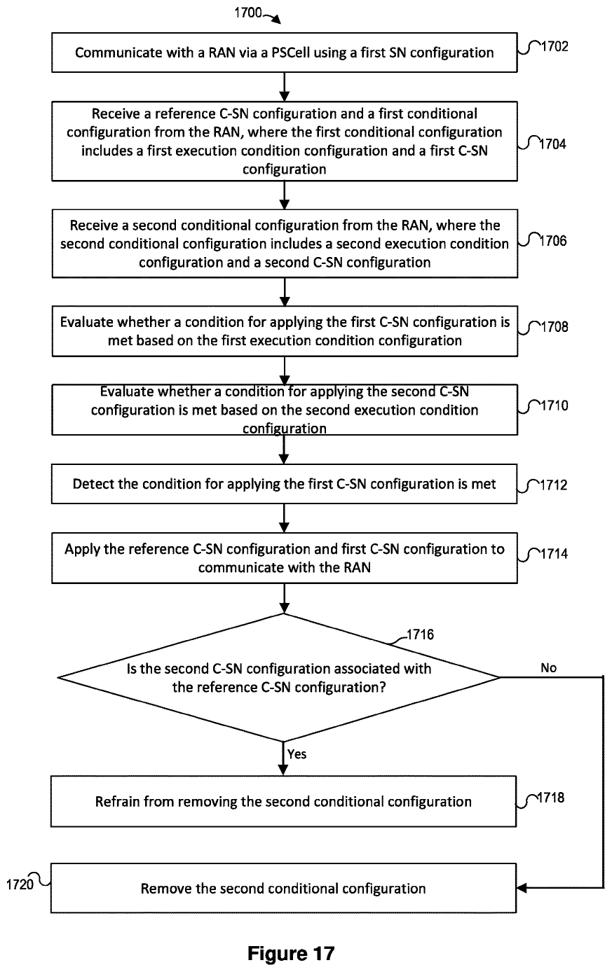

FIG. 17 illustrates a method 1700, which can be implemented by a UE (e.g., the UE 102), for performing a continuous CPAC procedure with a RAN (e.g., the RAN 105, or the base station 104A and/or 106B).

The method 1700 begins at block 1702, where the UE communicates with the RAN via a PSCell using a first SN configuration (e.g., event 301, 302, 401, 402). At block 1704, the UE receives a reference C-SN configuration and a first conditional configuration from the RAN, where the first conditional configuration includes a first execution condition configuration and a first C-SN configuration (e.g., event 308, 310, 408 or 409). The UE at block 1704 receives a second conditional configuration from the RAN, where the second conditional configuration includes a second execution condition configuration and a second C-SN configuration (e.g., event 308, 310, 408 or 409). At block 1708, the UE evaluates whether a condition for applying the first C-SN configuration is met based on the first execution condition configuration. At block 1710, the UE evaluates whether a condition for applying the second C-SN configuration is met based on the second execution condition configuration. In some implementations, the blocks 1708 and 1710 can be performed by the UE in parallel (i.e., not sequentially as shown in the figure). At block 1712, the UE detects the condition for applying the first C-SN configuration is met (e.g., event 316, 338, 416, or 438). At block 1714, the UE applies the reference C-SN configuration and first C-SN configuration to communicate with the RAN (e.g., event 336, 395, 436, or 495). At block 1716, the UE determines whether the second C-SN configuration is associated with the reference C-SN configuration. If the UE determines that the second C-SN configuration is associated with the reference C-SN configuration at block 1716, the flow proceeds to block 1718 where the UE refrain from removing the second conditional configuration (e.g., event 336, 395, 436, or 495). Otherwise, if the UE determines that the second C-SN configuration is not associated with the reference C-SN configuration at block 1716, the flow proceeds to block 1720 where the UE removes the second conditional configuration (e.g., event 336, 395, 436, or 495).

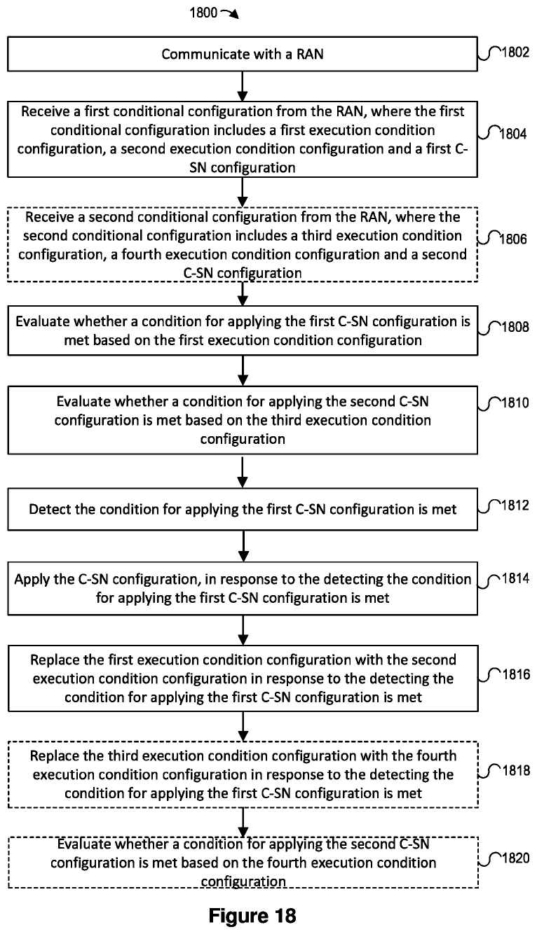

FIG. 18 illustrates a method 1800, which can be implemented by a UE (e.g., the UE 102), for performing a continuous CPAC procedure with a RAN (e.g., the RAN 105, or the base station 104A and/or 106B).

The method 1800 begins at block 1802, where the UE communicates with the RAN (e.g., event 301, 302, 401, 402). At block 1804, the UE receives a first conditional configuration from the RAN, where the first conditional configuration includes a first execution condition configuration, a second execution condition configuration and a first C-SN configuration (e.g., event 308, 310, 408 or 409). At block 1806, the UE can receive a second conditional configuration from the RAN, where the second conditional configuration includes a third execution condition configuration, a fourth execution condition configuration and a second C-SN configuration (e.g., event 308, 310, 408 or 409). At block 1808, the UE evaluates whether a condition for applying the first C-SN configuration is met based on the first execution condition configuration. At block 1810, the UE evaluates whether a condition for applying the second C-SN configuration is met based on the third execution condition configuration. In some implementations, the blocks 1808 and 1810 can be performed by the UE in parallel (i.e., not sequentially as shown in the figure). At block 1812, the UE detects the condition for applying the first C-SN configuration is met (e.g., event 316, 338, 416, or 438). At block 1814, the UE applies the C-SN configuration, in response to the detecting the condition for applying the first C-SN configuration is met (e.g., event 336, 395, 436, or 495). At block 1816, the UE replaces the first execution condition configuration with the second execution condition configuration in response to the detecting the condition for applying the first C-SN configuration is met. At block 1818, the UE can replace the third execution condition configuration with the fourth execution condition configuration in response to the detecting the condition for applying the first C-SN configuration is met. At block 1820, the UE can evaluate whether a condition for applying the second C-SN configuration is met based on the fourth execution condition configuration.

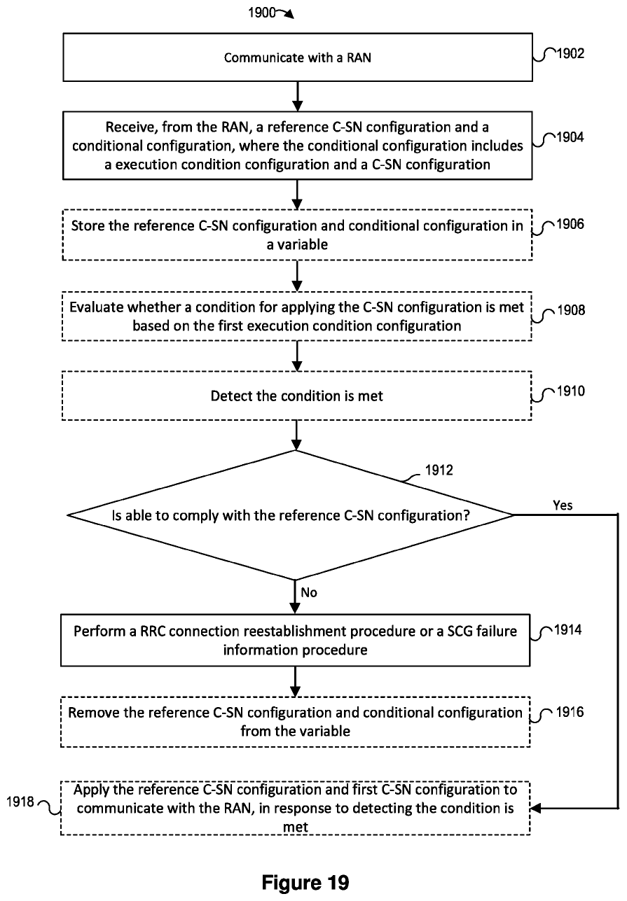

FIG. 19 illustrates a method 1900, which can be implemented by a UE (e.g., the UE 102), for performing a continuous CPAC procedure with a RAN (e.g., the RAN 105, or the base station 104A and/or 106B). The method 1900 begins at block 1902, where the UE communicates with a RAN (e.g., event 301, 302, 401, 402). At block 1904, the UE receives, from the RAN, a reference C-SN configuration and a conditional configuration, where the conditional configuration includes an execution condition configuration and a C-SN configuration (e.g., event 308, 310, 408 or 409).

At block 1906, the UE can store the reference C-SN configuration and conditional configuration in a variable. At block 1908, the UE can evaluate whether a condition for applying the C-SN configuration is met based on the first execution condition configuration. At block 1910 (optional), the UE determines the condition is met (e.g., event 316, 338, 416, or 438). At block 1912, the UE determines whether the UE is able to comply with the reference C-SN configuration. If the UE determines that the UE is not able to comply with the reference C-SN configuration at block 1912, the flow proceeds to bock 1914 where the UE performs a RRC connection reestablishment procedure or a SCG failure information procedure. At block 1916, the UE can remove the reference C-SN configuration and conditional configuration from the variable. Otherwise, if the UE determines that the UE is able to comply with the reference C-SN configuration, the flow proceeds to block 1918 (optional) where the UE applies the reference C-SN configuration and first C-SN configuration to communicate with the RAN (e.g., event 336, 395, 436, or 495) in response to detecting the condition is met.

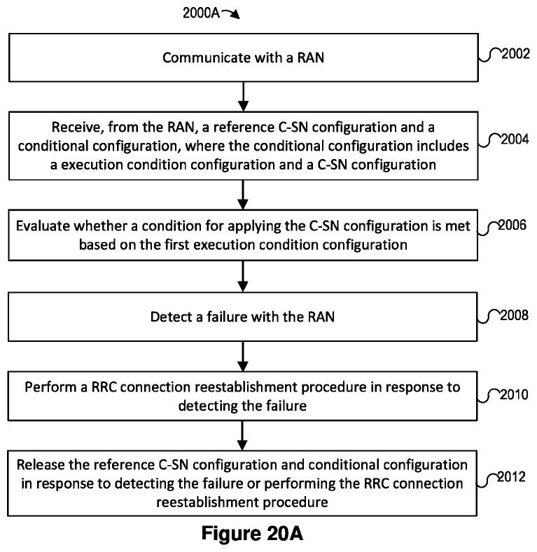

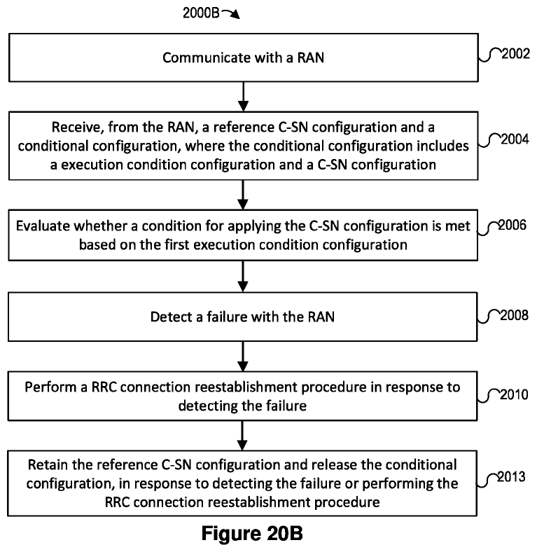

FIG. 20A illustrates a method 2000A, which can be implemented by a UE (e.g., the UE 102), for performing a continuous CPAC procedure with a RAN (e.g., the RAN 105, or the base station 104A and/or 106B).

The method 2000A begins at block 2002, where the UE communicates with the RAN (e.g., event 301, 302, 401, 402). At block 2004, the UE receives, from the RAN, a reference C-SN configuration and a conditional configuration, where the conditional configuration includes an execution condition configuration and a C-SN configuration (e.g., event 308, 310, 408 or 409). At block 2006, the UE evaluates whether a condition for applying the C-SN configuration is met based on the first execution condition configuration. At block 2008, the UE detects a failure with the RAN. At block 2010, the UE performs a RRC connection reestablishment procedure in response to detecting the failure. At block 2012, the UE releases the reference C-SN configuration and conditional configuration in response to detecting the failure or performing the RRC connection reestablishment procedure.

FIG. 20B illustrates a method 2000B similar to 2000A, except that the method 2000B includes block 2013 instead of block 2012. At block 2013, the UE retains the reference C-SN configuration and releases conditional configuration, in response to detecting the failure or performing the RRC connection reestablishment procedure.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”. In some implementations, “IE” is used and can be replaced by “field”. In some implementations, “configuration” can be replaced by “configurations” or the configuration parameters. In some implementations, the “CPAC”, “CPA” and/or “CPC” are interchangeable. In some implementations, “reference C-SN configuration” can be replaced by “reference SN configuration” or “reference configuration”. In some implementations, “triggering condition” and “triggering condition configuration” can be replaced by “execution condition” and “execution condition configuration”, respectively.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

The term “or” as used herein is to be interpreted as an inclusive or meaning any one or any combination, unless expressly indicated otherwise, mutually exclusive, or indicated otherwise by context. Therefore, herein, the expression “A or B” means “A, B, or both A and B.”

When implemented in software, the techniques can be provided as part of the operating system, a library used by multiple applications, a particular software application, etc. The software can be executed by one or more general-purpose processors or one or more special-purpose processors.

1. A method implemented in a first node of a radio access network (RAN), the method comprising:
transmitting, to a second node of the RAN, a request for a reference conditional secondary node (C-SN) configuration related to a continuous conditional primary secondary cell (PSCell) addition or change (CPAC) procedure;
receiving, from the second node and in response to the request, the reference C-SN configuration; and
transmitting, to a user equipment(UE), a C-SN configuration based on the reference C-SN configuration, for performing a plurality of conditional cell changes based on the C-SN configuration.

2. The method of claim 1, wherein the transmitting of the request includes:
transmitting an information element (IE) defined specifically for continuous CPAC.

3. The method of claim 1, wherein the request includes an SN Modification Request message.

4. The method of claim 3, wherein the C-SN configuration is received in an SN Modification Request Ack message.

5. The method of claim 1, further comprising:
receiving, from the second node and in response to the request, an indication of continuous CPAC.

6. The method of claim 1,
wherein the request transmitted to the second node is a first request, and the second node is a first candidate SN;
the method further comprising:
transmitting a second request to another candidate SN; and
receiving, in response to the second request, additional C-SN configuration.

7. The method of claim 6, wherein:
the second request includes the reference C-SN configuration received from the first candidate SN.

8. The method of claim 1:
the transmitting of the request for the reference C-SN configuration includes transmitting a first query indication; and
a request for a current SN configuration is transmitted using a second query indication.

9. The method of claim 1, wherein the transmitting of the C-SN configuration to the UE includes:
including the reference C-SN configuration in a first field of a radio resource control (RRC) message;
wherein a non-reference C-SN configuration is transmitted in a second field of the RRC message.

10. A method implemented in a second node of a radio access network (RAN), the method comprising:
receiving, from a first node of the RAN, a request for a reference conditional secondary node (C-SN) configuration related to a continuous conditional primary secondary cell (PSCell) addition or change (CPAC) procedure; and
transmitting, to the first node and in response to the request, the reference C-SN configuration.

11. The method of claim 10, wherein the receiving of the request includes:
transmitting an information element (IE) defined specifically for continuous CPAC.

12. The method of claim 10, wherein:
the reference C-SN configuration pertains to a plurality of candidate cells of the second node.

13. The method of claim 10, wherein:
the reference C-SN configuration is a delta configuration.

14. The method of claim 10, wherein:
the reference C-SN configuration is a full configuration.

15. A first node in a radio access network (RAN) comprising a transceiver and processing hardware, the node configured to:
transmit, to a second node of the RAN, a request for a reference conditional secondary node (C-SN) configuration related to a continuous conditional primary secondary cell (PSCell) addition or change (CPAC) procedure,
receive, from the second node and in response to the request, the reference C-SN configuration, and
transmit, to a user equipment (UE), a C-SN configuration based on the reference C-SN configuration, for performing a plurality of conditional cell changes based on the C-SN configuration.

16. The node of claim 15, wherein to transmit the request, the node is configured to:
transmit an information element (IE) defined specifically for continuous CPAC.

17. The node of claim 15, wherein the request includes an SN Modification Request message.

18. The node of claim 15, further configured to:
receive, from the second node and in response to the request, an indication of continuous CPAC.

19. The node of claim 15,
wherein the request transmitted to the second node is a first request, and the second node is a first candidate SN;
the node further configured to transmit a second request to another candidate SN; and
receiving, in response to the second request, additional C-SN configuration.

20. The node of claim 15, wherein:
the transmitting of the request for the reference C-SN configuration includes transmitting a first query indication; and
a request for a current SN configuration is transmitted using a second query indication.
